(19) United States
(12) Patent Application Publication
(10) Pub. No.: US 2018/0047255 A1
(43) Pub. Date: Feb. 15, 2018

(54) METHODS AND APPARATUS FOR POKER-BASED WAGERING GAME

(71) Applicant: Bally Gaming, Inc., Las Vegas, NV (US)

(72) Inventor: Ryan Masao Yee, Las Vegas, NV (US)

(21) Appl. No.: 15/232,741

(22) Filed: Aug. 9, 2016

(51) Int. Cl. G07F 17/32; A63F 1/00

(52) U.S. Cl. CPC G07F 17/3293; A63F 1/00; G07F 17/3211; G07F 17/3276; G07F 17/3225

(57) ABSTRACT

A poker-based wagering game includes a player and dealer each receiving three cards. The player discards one card. A shuffler device randomly selects a multiplier from a predefined set of multipliers. In an initial election event, the player is provided the options of checking or making a play wager equal to an earlier ante wager multiplied by the randomly selected multiplier (e.g., 2×, 3×, or 4×). Three community cards are dealt, and, in a final election event (provided the play wager was not earlier received), the player is provided the options of folding or making the play wager equal to the ante wager multiplied by another multiple (e.g., 1×). The ante and play wagers are resolved including comparing a five-card dealer hand to a five-card player hand, each formed from the five community cards as well as the three dealer cards and the two remaining player cards, respectively.

### FIELD

This disclosure relates generally to methods of administering wagering games for casinos and other gaming establishments, and related systems and apparatuses. More specifically, disclosed embodiments relate to methods of, and systems and apparatuses for, administering poker-based wagering games including player-vs-dealer wagers, at least one excess player card discarded before reveal of community cards, and an initial play election event including a play wager option defined by a randomly selected multiplier.

### BRIEF SUMMARY

In some embodiments, a method of administering a wagering game includes providing a gaming table. The gaming table includes a surface illustrated to define a plurality of player layouts. Each player layout is illustrated to define at least one distinct wager area. The at least one distinct wager area includes an Ante wager area and only one Play wager area. A shuffler device is also provided. The shuffler device includes a display and a random number generator programmed to randomly select a multiplier from a predefined set of multipliers. The method also includes administering a round of the wagering game. In the round, an ante wager is received in the Ante wager area of a player layout, of the plurality of player layouts, associated with a player. The random number generator of the shuffler device is used to randomly select the multiplier from the predefined set of multipliers. The multiplier is displayed on the display of the shuffler device. Three player cards are distributed from at least one deck of physical playing cards. The three player cards include one excess player card. Three dealer cards are distributed from the at least one deck of physical playing cards. The three dealer cards include one excess dealer card. After the player discards the one excess player card, which leaves two remaining player cards, an initial election is received. The initial election is selected by the player from options of a check election and a play wager to occupy the only one Play wager area of the player layout. The play wager, for the initial election, is equal to the ante wager multiplied by the multiplier randomly selected by the random number generator of the shuffler device. After receipt of the initial election, community cards, from the at least one deck of physical playing cards, are revealed. All received wagers are resolved. In the round of the wagering game, the dealer retains the three dealer cards, including the one excess dealer card, at least until all wagers in the round have been received.

In some embodiments, a method of administering a wagering game includes receiving an ante wager from a player. Three player cards are distributed from a deck of physical playing cards. Three dealer cards are distributed from the deck of physical playing cards. A shuffler device is operated to display, on a display of the shuffler device, a multiplier randomly selected, from a predefined set of multipliers, by a random number generator of the shuffler device. An initial election is received, which initial election is selected by the player from initial options consisting of a check election and a play wager equal to the ante wager multiplied by the multiplier displayed on the display of the shuffler device. After receipt of the initial election, after the player discards one of the three player cards to leave two remaining player cards, and before the dealer discards any of the three dealer cards, three community cards from the deck of physical playing cards are revealed. After revealing the three community cards and after receipt of the check election as the player-made selection for the initial election, a final election is received. The final election is selected by the player from final options consisting of a fold election and the play wager. The fold election sacrifices the ante wager, while the play wager for the final election is equal to the ante wager multiplied by another multiplier. After receiving the final election, another two community cards are revealed, to form five community cards, from the deck of physical playing cards. After receiving the final election and after revealing the another two community cards, a five-card dealer hand is formed from the three dealer cards and the five community cards. All received wagers still in play are resolved. The resolving includes comparing the five-card dealer hand to a five-card player hand formed from the two remaining player cards and the five community cards.

In some embodiments, a game system includes a regulated gaming machine primarily dedicated to playing at least one casino wagering game. The gaming machine includes an electronic display device and one or more electronic input devices. The gaming machine also includes game-logic circuitry configured to: detect, via at least one of the one or more electronic input devices, a physical item associated with a monetary value that establishes a credit balance; initiate a round of a casino wagering game of the at least one casino wagering game in response to an input indicative of an ante wager covered by the credit balance; and during the round of the casino wagering game: randomly select a multiplier from a predefined set of multipliers; display, on the electronic display device, the multiplier randomly selected; randomly select, from a stored deck of playing cards, three player cards and three dealer cards; display, on the electronic display device, the three player cards; receive an instruction, input by the player using at least one of the one or more electronic input devices, directing a discard of one of the three player cards; display, on the electronic display device, initial election options consisting of a check election, and a play wager election of an amount equal to the ante wager multiplied by the multiplier; receive an instruction, input by the player using at least one of the one or more electronic input devices, associated with one of the initial election options; randomly select, from the stored deck of playing cards, five community cards; display, on the electronic display device, the five community cards; after receipt of all wagers in the round of the casino wagering game, display on the electronic display device, the three dealer cards; and resolve at least the ante wager based at least in part on a comparison of a five-card player hand against a five-card dealer hand, the five-card player hand formed from the five community cards and three player cards less the discard one of the three player cards, the five-card dealer hand formed from the five community cards and the three dealer cards.

### BRIEF DESCRIPTION OF THE DRAWINGS

While this disclosure concludes with claims particularly pointing out and distinctly claiming specific embodiments, various features and advantages of embodiments within the scope of this disclosure may be more readily ascertained from the following description when read in conjunction with the accompanying drawings, in which:

FIGS. 1A and 1B together form a flowchart diagram of a method of administering a wagering game, according to an embodiment of this disclosure, FIG. 1B continuing from FIG. 1A;

FIG. 2 is a plan view illustrating a playing surface of a gaming table for implementation of a method of administering a wagering game, according to an embodiment of this disclosure;

FIG. 3 is an enlarged plan view illustrating a player layout of the playing surface of FIG. 2;

FIG. 4 is a perspective view of a gaming table configured for implementation of embodiments of wagering games in accordance with this disclosure;

FIG. 5 is a perspective view of an individual electronic gaming device configured for implementation of embodiments of wagering games in accordance with this disclosure;

FIG. 6 is a top view of a table configured for implementation of embodiments of wagering games in accordance with this disclosure;

FIG. 7 is a perspective view of another embodiment of a table configured for implementation of embodiments of wagering games in accordance with this disclosure, wherein the implementation includes a virtual dealer;

FIG. 8 is a schematic block diagram of a gaming system for implementing embodiments of wagering games in accordance with this disclosure;

FIG. 9 is a schematic block diagram of a gaming system for implementing embodiments of wagering games including a live dealer feed;

FIG. 10 is a block diagram of a computer for acting as a gaming system for implementing embodiments of wagering games in accordance with this disclosure;

FIG. 11 illustrates an embodiment of data flows between various applications/services for supporting the game, feature or utility of the present disclosure for mobile/interactive gaming;

FIG. 12 is a flowchart diagram of a method of administering a wagering game, which may be at least partially player-pooled, according to a player-pooled progressive embodiment; and

FIG. 13 is a flowchart diagram of a method of administering a wagering game, which may also be at least partially player-pooled, according to a dividend refund embodiment.

### DETAILED DESCRIPTION

The illustrations presented in this disclosure are not meant to be actual views of any particular act in a method, apparatus, system, or component thereof, but are merely idealized representations employed to describe illustrative embodiments. Thus, the drawings are not necessarily to scale. Additionally, elements common between figures may retain the same or similar numerical designation. Elements with the same number, but including a different alphabet character as a suffix should be considered as multiple instantiations of substantially similar elements and may be referred generically without an alphabet character suffix.

The terms “gaming,” “gambling,” or the like, refer to activities, games, sessions, rounds, hands, rolls, operations, and other events related to wagering games the outcome of which is at least partially based on one or more random events (“chance” or “chances”), and on which wagers may be placed by a player. In addition, the words “wager,” “bet,” “bid,” or the like, refer to any type of wager, bet, or gaming venture that is placed on random events, whether of monetary or non-monetary value. Points, credits, and other items of value may be purchased, earned, or otherwise issued prior to beginning the wagering game. In some embodiments, purchased points, credits, or other items of value may have an exchange rate that is not one-to-one to the currency used by the user. For example, a wager may include money, points, credits, symbols, or other items that may have some value related to a wagering game. Wagers may be placed in wagering games that involve the risk of real-world monetary value for the potential of payouts with real-world monetary value (e.g., the “play-for-pay,” such as “house-banked,” “player-banked,” “player-pooled” including “player-pooled progressive,” and “dividend refund” configurations, each of which is described in more detail below) or in wagering games that involve no real-world monetary risks for the player (e.g., the “play-for-fun” and “social play-for-fun” configurations described in more detail below).

As used herein, the term “wager” includes any form of wagering value, including money, casino chips, other physical means for payment, and online or remote electronic authorization of a wager in any acceptable form to the casino or online or virtual game host. Also included are physical representations of money (e.g., casino chips) at a local game, as well as virtual representations of money in the form of electronic authorizations of a transfer of money and digital representations of money (e.g., digital representations of bills or coins, digital representations of chips, numerical quantities of money, numerical quantities of points, or numerical quantities of credits) at a local or remote electronic gaming device. As used herein, the term “wagering element” means and includes objects and symbols used to signify the acceptance of a wager. For example, physical wagering elements include physical money (e.g., bills and coins) and physical wagering tokens (e.g., poker chips), which may or may not be redeemable for monetary value and may or may not include electronic identifiers (e.g., RFID chips) embedded within the tokens, enabling electronic sensing and tracking of wagering. Virtual wagering elements include, for example, images (e.g., images of money or poker chips) and text (e.g., a string of numbers), which may or may not be redeemable for monetary value. In the “play-for-fun” and “social play-for-fun” configurations, a “wager” may not have a cash value (i.e., a real-world monetary value).

For the purposes of this description, it will be understood that when an action related to accepting wagers, making payouts, dealing cards, selecting cards, or other actions associated with a player or a dealer is described herein, and such description includes a player or a dealer taking the action, the results of the action may be computer generated and may be displayed on a live or virtual table or electronic display, and, if applicable, the reception or detection of such an action in an electronic form where player and dealer choices, selections, or other actions are received at an electronic interface. This further includes the results of a virtual dealer and virtual players, where the actions described are actually generated by a computer (typically associated with an online game). By way of a further example, if dealing of a card is described herein, the description includes (but is not limited to) the following: the dealing of a card by a dealer from a deck, shuffler, shoe, or other card source and the reception or placement of the card at a table location associated with a player or reception directly by a player; the generation and transmission of an electronic indication or representation of a card from a game play source or server to an electronic receiver, where the receiver may be at a table (using virtual cards) including players and/or virtual players and/or a dealer or virtual dealer, on a gaming terminal, at a public display in a casino, at a remote location (e.g., using online or Internet game play), or at other locations. Also included is the representation of a card on a display or displays, and, if applicable to the action described, an electronic reception of an indication that the card has been received, selected, or otherwise interacted with at a location associated with a player, or, associated with a virtual player. In addition, dealing of a card may refer to revealing a representation of a card on a scratch-off card (also referred to as “scratchers”).

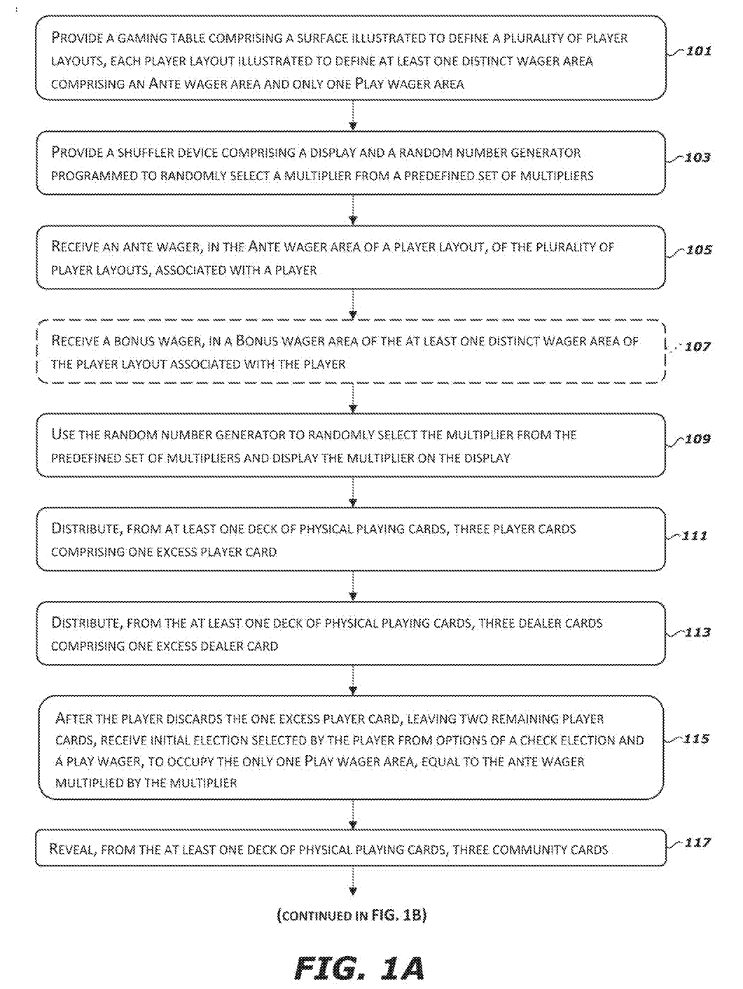

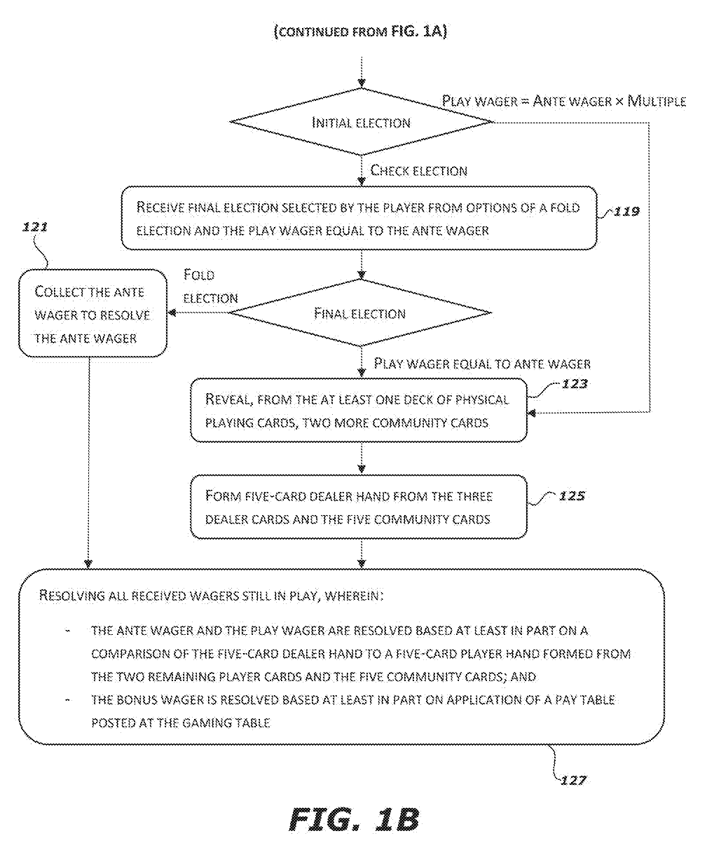

Referring to FIGS. 1A and 1B, a flowchart diagram of a method of administering a wagering game, according to at least one embodiment of the present disclosure, is shown. It is to be understood that, according to methods of the present disclosure, the dealer administers the game, and the dealer may receive certain play decisions from the player. Regardless of whether the player gives the instructions to the dealer or the dealer receives them, all steps are all considered steps of the administrator, namely, the dealer.

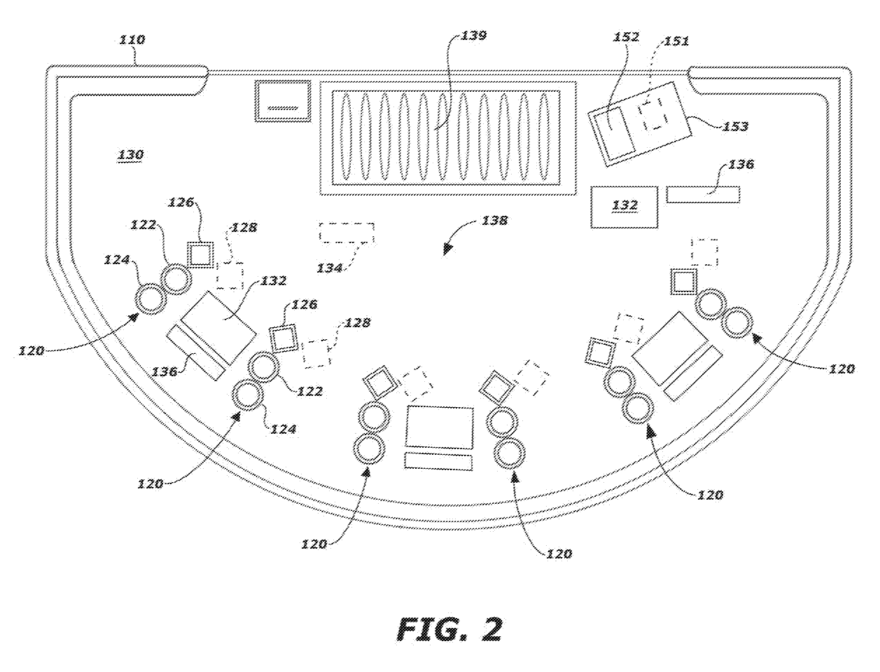

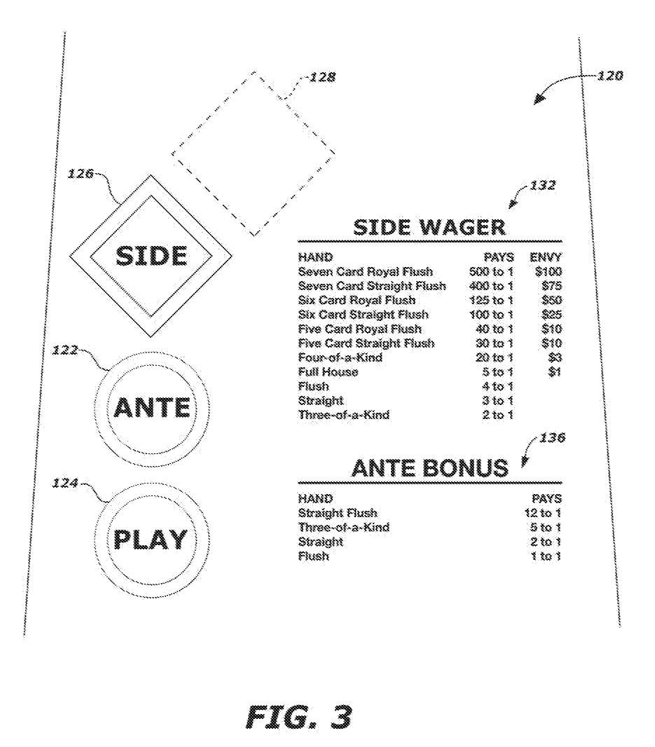

The method begins, at step 101 of FIG. 1A, by providing a gaming table (such as the gaming table illustrated in FIG. 2 (discussed further below)) having a surface illustrated to define a plurality of player layouts (such as the player layout illustrated in FIG. 3 (discussed further below)). Each player layout is illustrated to define at least one distinct wager area. A shuffler device (such as shuffler device 153 of FIG. 2 (discussed further below)) is provided, at step 103, is provided. The shuffler device 153 includes a display (such as display 152 of FIG. 2) and a random number generator (such as random number generator 151 of FIG. 2). The random number generator 151 is programmed to randomly select a multiplier from a predefined set of multipliers.

In some embodiments, the predefined set of multipliers consists of multipliers that are greater than a 1× multiplier. For example, the predefined set of multipliers may comprise or consist of a 2× multiplier, a 3× multiplier, and a 4× multiplier. The predefined set of multipliers may be defined, and the random number generator 151 programmed, such that the 2× multiplier is randomly selected from the predefined set about 60% of the time, the 3× multiplier is randomly selected from the predefined set about 25% of the time, and the 4× multiplier is randomly selected from the predefined set about 15% of the time, for example. In other embodiments, the random selection percentage may be varied. Nonetheless, in such other embodiments, the lowest multiplier of the predefined set may be most frequently selected, and the greatest multiplier of the predefined set may be least frequently selected.

An ante wager is received from a player, at step 105 of FIG. 1A. A bonus wager (which may also be known in the art as a “side wager”) may also be received from the player, at step 107. The bonus wager may be optional in some embodiments. In other embodiments, the bonus wager is mandatory, i.e., the receipt thereof is a prerequisite to the player's participation a round of the wagering game.

Optionally, a random number generator (e.g., a computerized random number generator included in a programmed gaming system (e.g., the random number generator 151 (FIG. 2) of the shuffler device 153); a die; a dial) is actuated to select which of a number of active player layouts will be first to receive cards for a player hand. By “active player layout,” it is meant a player layout at which at least the ante wager has been placed by a player.

At step 109, the random number generator 151 of the shuffler device 153 is used to randomly select the multiplier from the predefined set of multipliers. Also at step 109, the multiplier is displayed on the display 152 of the shuffler device 153.

At least one deck of playing cards may be provided for implementing the wagering game. In the embodiment of FIG. 1A, in which the wagering game is implemented on the gaming table with illustrated surface, the at least one deck of playing cards may consist of physical playing cards. In other embodiments, in which the wagering game is implemented electronically, the at least one deck of cards may consist of electronically-stored cards, as discussed in more detail below.

In some embodiments, the at least one deck of playing cards may consist of only one deck of playing cards, comprising or consisting of fifty-two standard cards ranked two through ace with four standard suits (i.e., hearts, spades, diamonds, and clubs). In other embodiments, more than one such deck of playing cards may be utilized to administer the wagering game.

In the embodiment of FIG. 1A, the at least one deck of physical playing cards may be loaded into the shuffler 153 (FIG. 2), and at least a portion of the at least one deck randomized by the shuffler.

At step 111, three player cards are distributed from the at least one deck of physical playing cards to each player layout on which the ante wager has been placed by a player. In some embodiments, the three player cards are distributed from the shuffler 153 face-down on the player layout surface, though the player may be enabled to view the three player cards. In other embodiments, the three player cards are distributed face-up on the player layout surface.

The three player cards include at least one excess player card. By “excess” card, it is mean a card that will be discarded or discounted or otherwise not included in a finally-formed player hand. Therefore, an “excess” card is not available for consideration in the resolution of at least one wager, such as the ante wager. An excess card not available for consideration in the resolution of one wager may nonetheless be considered in resolution of another wager, in some embodiments. In other embodiments, the excess card may not be available for consideration in the resolution of any wager from a round of the wagering game.

At step 113, three dealer cards are distributed, to a dealer card area on the layout, from the at least one deck of physical playing cards. The three dealer cards include at least one excess dealer card. The three dealer cards are distributed so as not to reveal the value of the cards to the players. For example, the three dealer cards may be dealt from the shuffler 153 and positioned face-down in the dealer card area on the layout at this step in the method.

Though FIG. 1A illustrates that step 109 (use of the random number generator to randomly select the multiplier) precedes step 111 (distribution of three player cards) and step 113 (distribution of three dealer cards), the order of steps 109, 111, and 113 may be in any order relative to one another. In some embodiments, step 109 (use of the random number generator to randomly select the multiplier) may precede step 105 (receipt of the ante wager) and step 107 (receipt of the bonus wager).

After the three player cards have been distributed (step 111) to each player layout with an active ante wager, the dealer receives, from each player with an active ante wager, one card, i.e., the excess player card, discarded by the respective player. The choice of which card to discard is the choice of the player, and the dealer accepts the election. After the discard, the player has two remaining player cards. Because, as will be described in more detail below, at least the ante wager will be resolved based at least in part on a poker rank of a player hand formed from cards that include the two remaining player cards, it is expected that the player will retain the two of the three player cards that are believed, by the player, to have the best likelihood of forming a part of a strong poker hand. Once discarded, the discarded card (i.e., the excess player card) will be in the possession of the dealer, and the card will no longer be available for inclusion in the player's hand on which at least the ante wager is to be resolved. In some embodiments, the discarded cards are collected in a discard tray or a card input area of the shuffler 153.

After the dealer has received the excess player card discarded by the player, an initial election event is administered, at step 115 of FIG. 1A. In the initial election event, an initial election is received by the dealer from the player. The initial election is selected, by the player, from options of a check election and a play wager that is equal to the ante wager multiplied by the multiplier randomly selected using the shuffler device 153 (FIG. 2) in step 109. By “check election” is mean a decision to pass on placing the play wager without sacrificing any wager in play. The options of the initial election may not include an option to fold.

As an example, in an iteration of a round of the gaming method of FIG. 1A, the random number generator may randomly select a multiplier of 2× at step 109. Therefore, in the initial election event, at step 115, the player is provided the options of the check election and a required play wager in the amount of 2× the ante wager. No other amount for the play wager, in the initial election event, may be permitted. However, in a subsequent round of the gaming method, the random number generator may randomly select a multiplier of 4× at step 109, such that, at step 115, the player has the options of the check election and a play wager of 4× the ante wager. Accordingly, the limitation on the first play wager opportunity, made available to the player by the dealer in administering the game, is defined by the randomly selected multiplier.

The randomness of the play wager amount generated by the random number generator for the initial election event adds a unique feature to a player-vs-dealer, poker-based wagering game. Piquing player interest in a new game generally involves adding interesting features that are nonetheless easy to understand by the players and easy to implement by the game administrator (i.e., the house). Conventionally, each round of a wagering game includes the same limitations on play wager amounts. Even where the limitations include a range of play wager amounts, the player's options nonetheless remain the same round after round. By embodiments of the present disclosure, however, the excitement of the game is substantially increased when a player is dealt good cards, e.g., at step 111, in the same round the multiplier happens to be selected to be a high multiplier.

The interesting feature of the randomized multiplier selection is further made unique by its combination with the feature of both the player and the dealer being provided an excess card. This provides additional considerations and strategy opportunities for the player. For example, where a player is provided three aces at step 111 and a high multiplier is selected at step 109, the player must consider whether a high play wager should be made when the opportunity to complete a four-of-a-kind must be sacrificed due to the requirement that the player discard one of the three aces.

By the dealer providing an excess card for the player and the dealer, there also exists an ability to improve a hand, regardless of the displayed multiplier. Providing the excess cards also adds excitement and intrigue to the game.

After the dealer has received a card that each player has discarded (i.e., the one excess player card) and after the initial election has been received from the player at step 115, the method proceeds to step 117 during which three community cards, from the at least one deck of playing cards, are revealed by placing the cards face-up in a community card area of the layout. In some embodiments, the three community cards may have been distributed face-down earlier in the method, to be revealed during this step 117. In other embodiments, the three community cards may be now distributed and revealed, such as by being dealt face-up directly from the shuffler device 153 (FIG. 2) onto the community card area of the layout.

After revealing the three community cards in step 117, the method proceeds to step 119 (FIG. 1B) if the received initial election, selected by the player in step 115, was the check election, i.e., if the play wager has not yet been received to the one Play wager area on the player layout. No more than one play wager may be placed by the player, and therefore received by the dealer or other game administrator on the Play wager area, during the round of the method. In other words, once a player has access to any card values, the player may place only one play wager. That is, the player may place only one wager that is in addition to wagers placed before any card values have been revealed (i.e., only one wager after the ante wager and any bonus wagers were received in steps 105 and 107).

As discussed further with regard to FIGS. 2 and 3, below, the gaming table may be configured with only one Play wager area in each player layout area such that the absence of a wager (in the form of a chip or token, e.g.) in the Play wager area after reveal of the three community cards quickly and simply indicates to both the dealer and the player that the initial election was the check election. In step 119, a final election event is administered. In that step, the dealer administers, and the player is provided, the options of a fold election and the play wager, but the play wager is equal to another multiplier times the ante wager. If the player previously placed a play wager in step 115, the player may only check. That is, once the play wager is made, the player is provided no other opportunity to place another wager, and the player also is not provided the option to fold.

In some embodiments, the multiplier applied in the final election event may be less than all multipliers included in the predefined set of multipliers from which the multiplier applied in the initial election event was randomly selected. For example, in some embodiments, the predefined set of multipliers for selecting the multiplier for the initial election event may comprise or consist of a 2× multiplier, a 3× multiplier, and a 4× multiplier while the multiplier for the final election event may be a 1× multiplier. In such embodiments, therefore, the play wager option of the final election event is an amount equal to the ante wager.

In other embodiments, the multiplier in step 119 may be randomly selected from a predefined set of multipliers, which set may be the same as or different than the predefined set of multipliers from which the earlier multiplier was randomly selected.

In some embodiments, while the multiplier applied during the initial election event is randomly selected by the random number generator 151 (FIG. 2) of the shuffler device 153 (FIG. 2), and can change from round to round, the multiplier applied during the final election event is not random and is consistent from round to round. In other embodiments, both multipliers are randomly selected using the random number generator, a game controller, or another processor external to the shuffler 153.

The selection of the fold election of step 119 “folds” the player's hand, sacrificing (i.e., losing) at least the ante wager, in step 121. In some embodiments, other wagers received by the dealer and made by the player, such as the bonus wager of step 107 made by receiving a wager on a designated bonus wager area on the player layout, remain in play. In other embodiments, selection of the fold election also sacrifices the bonus wager, if one was made by the player in step 107.

Once the dealer has received a play wager from a player, in either the initial election event (step 115) or the final election event (step 119), the method proceeds to step 123 with the dealer causing the revealing of two more community cards, in the community card area of the layout, from the at least one deck of playing cards. Because the final election event (step 119) was the final opportunity provided to the player to make the play wager, the reveal of the two more community cards in step 123 follows all wagering in the round of this embodiment of the method. The two more community cards may be distributed by the dealer and revealed by the dealer in step 123, or the two more community cards may have been earlier distributed (e.g., dealt face-down) and now revealed by the dealer to the player. With the revelation of the two more community cards, a total of eight cards are known to the player (i.e., the three cards distributed to the player in step 111 and the total of five community cards from steps 117 and 123). Though a total of eight cards are known to the player, the excess player card was previously discarded and is in the control of the dealer, before step 115. Therefore, upon completion of step 123, only seven cards are available for the player. The player can then form a final player hand, i.e., a best five-card poker hand, from the two remaining player cards (remaining after the discard of the player's excess card from the initial three player cards of step 111) and the five community cards. In some embodiments, the dealer may assist in selecting the best player hand, e.g., if requested by the player. In that case, the dealer sets the player hand the house way.

After the dealer reveals of all five community cards, i.e., following step 123, the dealer reviews the three dealer cards distributed in step 113 and reviews the five community cards located on the community card area of the layout. At step 125, a final dealer hand, i.e., a best five-card poker hand, is formed by the dealer from the eight cards then known and available to the dealer. The hand is selected by the dealer and arranged on the table in the dealer card area. Accordingly, while the player hand is formed with access to only seven cards (though with knowledge of eight cards), the dealer hand is formed with access to eight cards.

In some embodiments, the composition of the dealer hand must “qualify” (i.e., the dealer hand must at least equal or exceed a predefined qualifying minimum ranking, such as a pair of aces or better, or, in other embodiments, two pair or another ranking) for one or more of the wagers of the round to receive full action. For example, in some embodiments, if the dealer does not qualify with at least a pair of aces, the ante wager “pushes” (i.e., the wager is returned to the player with no payout thereon). If the dealer hand does not qualify, the play wager (if received in either the initial election event (step 115) or the final election event (step 119)) may nonetheless remain in play for resolution in step 127. However, if the dealer hand does qualify with at least the predefined qualify ranking (e.g., the pair of aces), then the ante wager and the play wager (if received in either step 115 or step 119) remain in play resolution in step 127.

In other embodiments, there is no qualifying requirement for the dealer. In such embodiments, regardless of the content of the dealer hand, all received wagers still in play at step 123 move forward for resolution in step 127.

In step 127, all wagers still in play following step 125 are resolved. As used herein, the term “in play,” when referring to any wager, means a wager that has been received from a player and has not yet been sacrificed or otherwise resolved. Thus, if the fold election was received by the player in the final election event of step 119, meaning that the ante wager was sacrificed (i.e., surrendered to the house) in step 121 and that no play wager was received from the player during the round, neither the ante wager nor the play wager is in play to be resolved in step 127. The ante wager is not in play at step 127 due to the folding, and the play wager is not in play at step 127 due to its never having been received in the Play wager area from the player during the round.

In some embodiments, even if the fold election was received, by the dealer, from the player in the final election event (step 119), the bonus wager (if received at step 107) may remain in play to be resolved at step 127.

Resolving the ante wager and the play wager, in step 127, provided these wagers remain in play at step 127, includes comparing the best five-card player hand to the best five-card dealer hand. If the five-card player hand has a higher poker ranking than the five-card dealer hand, the ante wager and the play wager win and a 1 to 1 payout (i.e., a payout equal to the combined amount of the ante wager and the play wager) is paid to the player. If the five-card player hand has a lower poker ranking than the five-card dealer hand, the ante wager and the play wager lose and are retained by the dealer. If the five-card player hand as a poker rank equal to the five-card dealer hand (i.e., the hands tie), the ante wager and the play wager push. Accordingly, the ante wager and the play wager are player-vs-dealer wagers, resolved based at least in part on a comparison of the player hand to the dealer hand. Thus, the ante wager and the play wager are wagered against the “house,” and not against other players in the round.

If the bonus wager was received in a bonus wager area on the layout in step 107, and remains in play at step 127, it is also resolved at step 127. In some embodiments, more than one bonus wager option may be been made available to the player by the house and may have been received from the player at step 107. Whether or not each such bonus wager is sacrificed upon receipt of the fold election during step 119 may be predefined by the game administrator. In some embodiments, all bonus wagers received for the round may remain in play even if the player folded at step 119.

In some embodiments, the bonus wager that may be received at 107 in a bonus wager area on the layout, may remain in play regardless of receipt of the fold election at step 119, and resolved at step 127 may be a wager against a pay table. That is, the bonus wager may be resolved based at least in part on application of a predefined pay table, which may be posted at the gaming table on the layout, on a static sign, or on an electronic display such as a shuffler display. In some such embodiments, the bonus wager may be resolved based also at least in part on composition of the seven cards available to the player following step 123, i.e., the two remaining player cards (following the discard of the excess player card) and the five community cards. For example, a pay table such as TABLE I_{A}, below, may be applied to a seven-card poker ranking of the seven-card player hand, where a bonus payout (see “Pays” column) is an odds payout based on the amount of an associated bonus wager received in a bonus wager area on the layout at step 107. With respect to the odds payout, the bonus payout may not be impacted by whether the five-card player hand ranked higher, lower, or the same as the five-card dealer hand and may not be impacted by whether the seven-card player hand ranks higher, lower, or the same as a corresponding dealer hand.

In some such embodiments, the bonus wager may be further resolved by paying a bonus to the dealer based at least in part on composition of the seven-card player hand. This “Dealer Envy” bonus (see “Dealer Envy” column) is determined based on the ranking of the seven-card player hand, regardless of whether the seven-card player hand outranks, ties, or is outranked by the seven-card dealer hand. The additional bonus payout may be a fixed monetary amount based on the seven-card player hand rank. The amount of the bonus wager received in step 107 may be required to be a particular amount, such as a $1 side wager.

Where the embodiment includes a dealer qualification requirement for resolution of the ante wager, the resolution of the bonus wager may be independent of whether the dealer hand qualified. In other words, even if the dealer hand does not qualify, the bonus wager may remain in play and be resolved in step 127.

For example, in an iteration of the method according to the embodiment of FIGS. 1A and 1B and including a bonus wager against the pay table of TABLE 1_{A}, the five community cards may result in being 10 [symbol] , 9 [symbol] , 8 [symbol] , 7 [symbol] , and A [symbol] ; the player's remaining two cards may result in being 6 [symbol] and 5 [symbol] (after, for example, discarding a 3♡ as the excess player card); and the dealer's three cards may result in being A♡, A♦, and A [symbol] . Thus, the five-card player hand is a straight flush with 10 [symbol] high (i.e., 10 [symbol] , 9 [symbol] , 8 [symbol] , 7 [symbol] , and 6 [symbol] ); the five-card dealer hand is a four-of-a-kind of aces (i.e., A [symbol] , A♡, A♦, A [symbol] , and 10 [symbol] ); the seven-card player hand is a six-card straight flush with 10 [symbol] high (i.e., 10 [symbol] , 9 [symbol] , 8 [symbol] , 7 [symbol] , 6 [symbol] , and 5 [symbol] ); and the seven-card dealer hand is a four-of-a-kind of aces (i.e., A [symbol] , A♡, A♦, A [symbol] , 10 [symbol] , 9 [symbol] , and 8 [symbol] ). If the play wager was received from the player in either the initial election event (step 115) or the final election event (step 119), resolving the ante wager and the play wager in step 127 results in both wagers winning a 1 to 1 payout because the five-card dealer hand of a four-of-a-kind of aces is outranked by the five-card player hand of a straight flush with 10 [symbol] high. A bonus payout of 100 to 1, on the bonus wager, would be distributed to the player for the six-card straight flush. An additional “dealer envy” bonus payout of $3 would be distributed to the dealer for the seven-card player hand of the six-card straight flush.

TABLE I_{A}

| Hand | Pays | Dealer Envy |
|---|---|---|
| 7-Card Royal Flush | 500 to 1 | $100 |
| 7-Card Straight Flush | 400 to 1 | $75 |
| 6-Card Royal Flush | 125 to 1 | $50 |
| 6-Card Straight Flush | 100 to 1 | $25 |
| 5-Card Royal Flush | 40 to 1 | $10 |
| 5-Card Straight Flush | 30 to 1 | $10 |
| Four-of-a-Kind | 20 to 1 | $3 |
| Full House | 5 to 1 | $1 |
| Flush | 4 to 1 | n/a |
| Straight | 3 to 1 | n/a |
| Three-of-a-Kind | 2 to 1 | n/a |

In an alternate embodiment, TABLE I_{B}, below, may be used to resolve the bonus wager, in place of TABLE I_{A}.

TABLE I_{B}

| Hand | Pays | Dealer Envy |
|---|---|---|
| 7-Card Royal Flush | 500 to 1 | $100 |
| 7-Card Straight Flush | 400 to 1 | $75 |
| 6-Card Royal Flush | 125 to 1 | $50 |
| 6-Card Straight Flush | 100 to 1 | $25 |
| 5-Card Royal Flush | 40 to 1 | $10 |
| 5-Card Straight Flush | 30 to 1 | $10 |
| Four-of-a-Kind | 20 to 1 | $10 |
| Full House | 5 to 1 | $3 |
| Flush | 4 to 1 | $2 |
| Straight | 3 to 1 | $1 |

In another alternate embodiment, TABLE I_{C}, below, may be used to resolve the bonus wager, in place of TABLE I_{A} or TABLE I_{B}.

TABLE I_{C}

| Hand | Pays | Dealer Envy |
|---|---|---|
| 7-Card Royal Flush | 500 to 1 | $100 |
| 7-Card Straight Flush | 400 to 1 | $75 |
| 6-Card Royal Flush | 300 to 1 | $50 |
| 6-Card Straight Flush | 200 to 1 | $25 |
| 5-Card Royal Flush | 100 to 1 | $10 |
| 5-Card Straight Flush | 40 to 1 | $10 |
| Four-of-a-Kind | 30 to 1 | $3 |
| Full House | 6 to 1 | $1 |
| Flush | 5 to 1 | n/a |
| Straight | 4 to 1 | n/a |
| Three-of-a-Kind | 2 to 1 | n/a |

In some embodiments, the bonus wager received at step 107 may be a “two-way bad beat” bonus wager. This wager may be optional (i.e., not required in addition to the ante wager, and not a prerequisite for the player to make the ante wager, to make the play wager, or for the underlying wagering game to be carried out). In some embodiments, the two-way bad beat bonus wager may be a second side wager option, in addition to the aforementioned bonus wager against the pay tables such as those of TABLES I_{A} through I_{C}. In some embodiments, the two-way bad beat bonus wager may be sacrificed upon folding in step 119.

The two-way bad beat bonus wager may also be designed to be resolved based at least in part on application of a pay table, such as any of TABLES II_{A} and II_{B}, below, to a losing five-card hand. In other words, a lower-ranking hand of the five-card player hand and the five-card dealer hand is applied against TABLE II_{A} or TABLE II_{B} to determine a bad beat payout. More particularly, if the five-card player hand is the lower-ranking hand (i.e., the beaten hand), the rank of the losing five-card player hand is applied to the pay table to determine a bad beat payout according to the “Pays” column, i.e., an odds payout based on the amount of the two-way bad beat bonus wager received in step 107; however, if the five-card dealer hand is the lower-ranking hand (i.e., the beaten hand), the rank of the losing five-card dealer hand is applied to the pay table to determine a bad beat payout according to the same pays column. Additionally, a “Dealer Envy” payout is made to the dealer, based on the amounts shown in the Dealer Envy column, i.e., a fixed monetary amount, when certain losing hands are beaten, such as a hand composition of a straight or better.

For example, in an embodiment having a two-way bad beat bonus wager against the pay table of TABLE II_{A}, if the five-card player hand is a four-of-a-kind and loses to a five-card dealer hand of a straight flush, a payout of 20 to 1 is paid to the player for the beaten four-of-a-kind player hand. However, if the dealer hand is the four-of-a-kind and loses to a five-card player hand of a straight flush, the payout of 20 to 1 is still paid to the player for the beaten four-of-a-kind dealer hand. A Dealer Envy bonus of $10 is also paid to the dealer for the losing four-of-a-kind.

TABLE II_{A}

| Losing Hand | Pays | Dealer Envy |
|---|---|---|
| Royal Flush | 40 to 1 | $10 |
| Straight Flush | 30 to 1 | $10 |
| Four-of-a-Kind | 20 to 1 | $10 |
| Full House | 5 to 1 | $3 |
| Flush | 4 to 1 | $2 |
| Straight | 3 to 1 | $1 |
| Three-of-a-Kind | 1 to 1 | n/a |

TABLE II_{B}

| Losing Hand | Pays | Dealer Envy |
|---|---|---|
| Straight Flush | 100 to 1 | $20 |
| Four-of-a-Kind | 50 to 1 | $10 |
| Full House | 30 to 1 | $2 |
| Flush | 25 to 1 | $1 |
| Straight | 10 to 1 | $1 |
| Three-of-a-Kind | 5 to 1 | n/a |

In some embodiments, resolving wagers in step 127 may further include determining a possible bonus award for which the player is automatically entered, upon placing the ante wager, without having to make an additional wager. Herein, this bonus award is referred to as an “ante bonus.” The ante bonus may be awarded, based on application of a pay table such as either TABLE III_{A} or TABLE III_{B}, below, to the five-card player hand. The ante bonus may be awarded regardless of the relative composition of the dealer's hand (and, therefore, regardless of whether the player's hand beat, lost to, or tied the dealer's hand). The amount of the ante bonus may be based on the amount of the ante wager. In some embodiments, if the fold election is received from the player in the final election event of step 119, sacrificing the ante wager, the potential for the ante bonus is also lost.

TABLE III_{A}

| Hand | Pays |
|---|---|
| Straight Flush | 12 to 1 |
| Three-of-a-Kind | 5 to 1 |
| Straight | 2 to 1 |
| Flush | 1 to 1 |

TABLE III_{B}

| Hand | Pays |
|---|---|
| Royal Flush | 10 to 1 |
| Straight Flush | 5 to 1 |
| Four-of-a-Kind | 4 to 1 |
| Full House | 3 to 1 |
| Flush | 2 to 1 |
| Straight | 2 to 1 |
| Three-of-a-Kind | 1 to 1 |

### EXAMPLE

As an example of a particular embodiment of the methods of the present disclosure, the method may include the bonus wager against the pay table of TABLE I_{B}, discussed above, as well as the two-way bad beat bonus wager against the pay table of TABLE II_{A}, discussed above. This particular embodiment of the method may be referred to herein as “HIC Hold'em Poker.” At step 105, the ante wager is received, and the optional bonus wager against TABLE I_{B} (which may be referred to herein as a “Big Kahuna Bonus” wager) and the optional two-way bad beat bonus wager may be received at step 107. A multiplier is randomly selected, by the random number generator 151 (FIG. 2) of the shuffler device 153, from a predefined set of multipliers consisting of a 2× multiplier (with a probability of selection of 60%), a 3× multiplier (with a probability of selection of 25%), and a 4× multiplier (with a probability of selection of 15%). The randomly selected multiplier is displayed to the player on the display 152 (FIG. 2) of the shuffler device.

Three player cards are dealt from the shuffler device 153 and are delivered to the player card area of the layout by the dealer at step 111. Three dealer cards are dealt from the shuffler device 153 and delivered by the dealer to the dealer card position 138 of the layout at step 113. The player discards, and the dealer accepts, one of the three player cards, leaving two remaining player cards.

An initial election event is then administered at step 115, with the player making, and the dealer receiving, a selection between the options of checking or making a play wager equal to the randomly selected multiplier multiplied by the ante wager.

Three community cards (the “flop”) are revealed by the dealer, by placing the cards face-up on in the community card area of the layout, on the gaming table, at step 117. Alternatively, the cards may already be present in the community card area of the layout and may be turned face-up. Provided the play wager was not received in the initial election event, a final election event is then administered at step 119, with the player making a selection between the options of folding or making the play wager equal to the ante wager (i.e., equal to 1× the ante wager). If the player folds, the ante wager is lost at step 121, but the play wager and the bonus wagers (if received) remain in play. In some embodiments, only one play wager may be received by the dealer from each player in a round of play.

Fourth and fifth community cards (the “turn” and the “river”) are then revealed on the gaming table at step 123. The dealer forms a best five-card dealer hand from the dealer's three cards and the five community cards, at step 125. The player forms a best five-card player hand from the remaining two player cards and the five community cards. In some embodiments, the dealer may assist the player in determining the best five-card player hand.

The dealer must qualify with at least a pair of aces. If the dealer does not qualify, the ante wager (if still in play) is pushed (returned to the player), and the play wager remains in play to be resolved.

All received wagers that are still in play are then resolved at step 127. The ante wager and the play wager receive a 1 to 1 payout if the five-card player hand outranks the five-card dealer hand. The ante wager and the play wager are lost to the house if the five-card player hand is outranked by the five-card dealer hand. The ante wager and the play wager push if the five-card player hand is of equal rank to the five-card dealer hand. The bonus wager is resolved based on application of TABLE I_{B} against a seven-card player hand (consisting of the two remaining player cards and the five community cards), with a first bonus payout awarded for the seven-card player hand matching a ranking in the pay table. The two-way bad beat bonus wager is resolved based on application of TABLE II_{A} against an outranked (losing) hand of the five-card player hand and the five-card dealer hand, provided the player did not fold in step 119. Had the player folded in step 119, the two-way bad beat wager would have been sacrificed along with the ante wager. In this embodiment, no ante bonus is available.

Following resolution of the wagers, the playing cards are collected from the gaming table and returned to the shuffler device 153 for randomization of the at least one deck of playing cards for a next round.

Various platforms are contemplated that are suitable for implementation of embodiments of wagering games according to this disclosure. For example, embodiments of wagering games may be implemented as live table games with an in-person dealer, electronic gaming machines, partially or fully automated table games, and partially or fully automated, network-administered games (e.g., Internet games) wherein game results may be produced utilizing a processor or a live video feed of a dealer administering a game from a remote studio.

As previously noted, any of the present methods and games may be played as a live casino table card game, as a hybrid casino table card game (with virtual cards or virtual chips), on a multi-player electronic platform (as disclosed in U.S. patent application Ser. No. 10/764,827, filed Jan. 26, 2004, published as U.S. Patent Application Publication No. 2005/0164759 on Jul. 28, 2005, now abandoned; U.S. patent application Ser. No. 10/764,994, filed Jan. 26, 2004, now U.S. Pat. No. 7,661,676, issued Feb. 16, 2010; and U.S. patent application Ser. No. 10/764,995, filed Jan. 26, 2004, now U.S. Pat. No. 8,272,958, issued Sep. 25, 2012; the disclosure of each of which applications and patents is incorporated herein in its entirety by this reference), on a personal computer for practice, on a hand-held game for practice, on a legally authorized site on the Internet, or on a play-for-fun site on the Internet.

For example, in one embodiment, the players may be remotely located from a live dealer, and a live dealer and a game table may be displayed to players on their monitors via a video feed. The players' video feeds may be transmitted to the dealer and may also be shared among the players at the table. In a sample embodiment, a central station may include a plurality of betting-type game devices and an electronic camera for each game device. A plurality of player stations, remotely located with respect to the central station, may each include a monitor, for displaying a selected game device at the central station, and input means, for selecting a game device and for placing a bet by a player at the player's station relating to an action involving an element of chance to occur at the selected game device. Further details on gambling systems and methods for remotely located players are disclosed in U.S. Pat. No. 6,755,741 B1, issued Jun. 29, 2004, titled “GAMBLING GAME SYSTEM AND METHOD FOR REMOTELY-LOCATED PLAYERS,” the disclosure of which is incorporated herein in its entirety by this reference.

FIG. 2 is a diagram of a playing surface 130 of a gaming table 110 for implementing wagering games within the scope of this disclosure. A dealer carries out the administration of the wagering games by using the provided gaming table 110 at which one or more players may each sit in association with a player layout 120 of a plurality of player layouts 120. The playing surface 130 further includes a dealer card position 138 between a chip tray 139 and the player layouts 120.

The at least one deck of physical playing cards may be fed to the shuffler device 153, which includes the display 152 and the random number generator 151 programmed to randomly select the multiplier, for the initial election event, from the predefined set of multipliers. The shuffler device 153 may be provided on, provided adjacent to, or supported in the playing surface 130 of the gaming table 110.

FIG. 3 is an enlarged diagram of one of the player layouts 120 of the playing surface 130 of FIG. 2. Each player layout 120 includes at least one visually distinguishable wager area, which may be delineated by one or more circles or other shapes. Where multiple shapes are used to delineate the areas, as in FIGS. 2 and 3, one shape (e.g., circles) may designate required wagers, while another shape (e.g., diamonds) may designate optional wagers.

The at least one distinct wager player area includes an Ante wager area 122 and only one Play wager area 124. Configuring the player layout 120 to include only one Play wager area 124 enables the game administrator to quickly identify whether or not the player has made a play wager during the game, because once the play wager is played, no additional play wager may be made in the round.

The at least one distinct player wager area may also include one or bonus wager areas, such as a Side wager area 126, and, optionally, also a two-way bad beat wager area 128. A pay table 132 (e.g., TABLE I_{A}, above) may be imprinted on the playing surface 130 in association with the Side wager area 126. In embodiments in which the two-way bad beat wager area 128 is included in the player layout 120, a two-way bad beat pay table 134 (e.g., TABLE II_{A} or TABLE II_{B}) may also be imprinted on the playing surface 130. In other embodiments, the pay tables 132, 134 may be provided on a removable plaque, on another removable display, or on an electronic display such as the shuffler display 152.

Another pay table 136 (e.g., TABLE III_{A}), for a bonus award, such as the above-discussed ante bonus, may also be imprinted on the playing surface 130.

In some embodiments, the wagering games described herein may be played against a game administrator (i.e., against “the house” such that the game is “house-banked”). Such implementations may involve the game administrator (e.g., a casino or other gaming establishment) accepting (e.g., via a dealer or other agent of the administrator) wagers of real-world monetary value, distributing payouts of real-world monetary value on winning wagers to players, and collecting real-world monetary value of lost wagers. Such “house-banked” embodiments may be implemented, for example, in the form of a live table game, in a virtual table game, in an electronic game, or in a networked (e.g., Internet) game configuration.

In other embodiments, the wagering games, or at least one wager associated with the wagering games, may involve a player in a casino or other gaming establishment acting as banker, accepting wagers having real-world monetary value, issuing payouts having real-world monetary value, and collecting real-world monetary value of lost wagers (i.e., be “player-banked”). In some embodiments where at least one wager is player-banked, the game administrator may collect a player entrance fee, or a rake on each player-banked wager accepted from the participating players, including the banker.

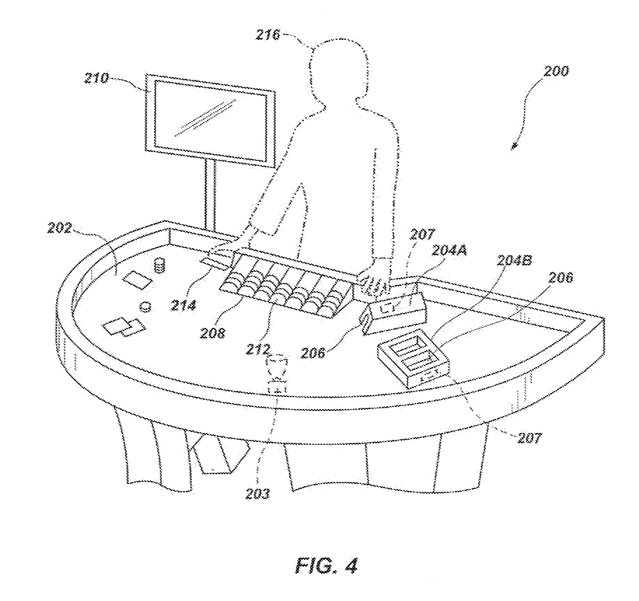

FIG. 4 is a perspective view of an embodiment of a gaming table 200 (which may be configured as the gaming table 110 of FIG. 2) for implementing wagering games in accordance with this disclosure. The gaming table 200 may be a physical article of furniture around which participants in the wagering game may stand or sit and on which the physical objects used for administering and otherwise participating in the wagering game may be supported, positioned, moved, transferred, and otherwise manipulated. For example, the gaming table 200 may include a gaming surface 202 (which may be configured as the gaming surface 130 of FIG. 2) on which the physical objects used in administering the wagering game may be located. The gaming surface 202 may be, for example, a felt fabric covering a hard surface of the table, and a design, conventionally referred to as a “layout,” specific to the game being administered may be physically printed on the gaming surface 202. As another example, the gaming surface 202 may be a surface of a transparent or translucent material (e.g., glass or plexiglass) onto which a projector 203, which may be located, for example, above or below the gaming surface 202, may illuminate a layout specific to the wagering game being administered. In such an example, the specific layout projected onto the gaming surface 202 may be changeable, enabling the gaming table 200 to be used to administer different variations of wagering games within the scope of this disclosure or other wagering games. Additional details of illustrative gaming surfaces and projectors are disclosed in U.S. patent application Ser. No. 13/919,849, filed Jun. 17, 2013, and titled “ELECTRONIC GAMING DISPLAYS, GAMING TABLES INCLUDING ELECTRONIC GAMING DISPLAYS AND RELATED ASSEMBLIES, SYSTEMS AND METHODS,” the disclosure of which is incorporated herein in its entirety by this reference. In either example, the gaming surface 202 may include, for example, designated areas for player positions (such as the player layouts 120 of FIGS. 2 and 3); areas in which one or more of player cards, dealer cards, or community cards may be dealt; areas in which wagers may be accepted; areas in which wagers may be grouped into pots; and areas in which rules, pay tables, and other instructions related to the wagering game may be displayed. As a specific, nonlimiting example, the gaming surface 202 may be configured as the gaming surface 130 shown in FIG. 2, with the player layouts 120 shown in FIGS. 2 and 3.

In some embodiments, the gaming table 200 may include a display 210 separate from the gaming surface 202. The display 210 may be configured to face players, prospective players, and spectators and may display, for example, the multiplier randomly selected by the shuffler device 153 and also displayed on the display 152 of the shuffler device 153; rules; pay tables (such as pay tables 132, 134, and/or 136); real-time game status, such as wagers accepted and cards dealt; historical game information, such as amounts won, amounts wagered, percentage of hands won, and notable hands achieved; and other instructions and information related to the wagering game. The display 210 may be a physically fixed display, such as a poster, in some embodiments. In other embodiments, the display 210 may change automatically in response to a stimulus (e.g., may be an electronic video monitor).

The gaming table 200 may include particular machines and apparatuses configured to facilitate the administration of the wagering game. For example, the gaming table 200 may include one or more card-handling devices 204A, 204B. The card-handling device 204A may be, for example, a shoe from which physical cards 206 from one or more decks of playing cards may be withdrawn, one at a time. Such a card-handling device 204A may include, for example, a housing in which cards 206 are located, an opening from which cards 206 are removed, and a card-presenting mechanism (e.g., a moving weight on a ramp configured to push a stack of cards down the ramp) configured to continually present new cards 206 for withdrawal from the shoe. Additional details of an illustrative card-handling device 204A configured as a shoe are found in U.S. Patent App. Pub. No. 2010/0038849, published Feb. 18, 2010, and titled “INTELLIGENT AUTOMATIC SHOE AND CARTRIDGE,” the disclosure of which is incorporated herein in its entirety by this reference.

In some embodiments in which the card-handling device 204A is used, the card-handling device 204A may include the random number generator 151 (FIG. 2) and the display 152, in addition to or rather than such features being included in a shuffler device.

In addition to the card-handling device 204A, the card-handling device 204B may be included. The card-handling device 204B may be, for example, a shuffler (such as the shuffler device 153 of FIG. 2) configured to randomly select (using the random number generator 151) the multiplier for the initial election event from the predefined set of multipliers, to display the randomly selected multiplier on the display 152, to reorder physical cards 206 from one or more decks of playing cards, and to present randomized cards 206 for use in the wagering game. Such a card-handling device 204B may include, for example, a housing, a shuffling mechanism configured to shuffle cards, and card inputs and outputs (e.g., trays). Additional details of an illustrative card-handling device 204B configured as a shuffler are found in U.S. Pat. No. 8,070,574, issued Dec. 6, 2011, to Grauzer et al., the disclosure of which is incorporated herein in its entirety by this reference. Shufflers such as the devices disclosed in the '574 patent may include card recognition capability and may form randomly ordered hands of a known composition within the shuffler. Additionally, game rules may also be programmed within the shuffler such that the processor of the shuffler is capable of identifying a winning hand prior to automatic delivery into an output tray. The card-handling device 204 may also be, for example, a combination shuffler and shoe in which the output for the shuffler is a shoe.

In some embodiments, the card-handling device 204 may be configured and programmed to administer at least a portion of a wagering game being played utilizing the card-handling device 204. For example, the card-handling device 204 may be programmed and configured to randomize a set of cards and present one or more cards for use according to game rules. More specifically, the card-handling device 204 may be programmed and configured to, for example, randomize a set of cards including one or more 52-card decks of standard playing cards and, optionally, any specialty cards (e.g., a cut card, bonus cards, wild cards, or other specialty cards). In some embodiments, the card-handling device 204 may present individual cards, one at a time, for withdrawal from the card-handling device 204. In other embodiments, the card-handling device 204 may present packets of cards representing a subset of the complete set of cards handled by the card-handling device 204 (e.g., individual hands, one hand at a time, a group of hands, a partial hand or hands and then additional cards as needed to complete the hand or hands, a hand or hands and any burn or specialty cards to be used in the same round as the hand or hands) for withdrawal from the card-handling device 204. In some such embodiments, the card-handling device 204 may accept dealer input, such as, for example, a number of replacement cards for discarded cards, a number of hit cards to add, or a number of partial hands to be completed. In other such embodiments, the device may accept a dealer input from a menu of game options indicating a game selection, which will select programming to deliver the requisite number of cards to the game and to randomly select the multiplier, depending on the game rules. The game rules and the predefined set of multipliers, including the probabilities for selection of each member of the set, may be programmed into the memory of the shuffler processing system. In still other embodiments, the card-handling device 204 may present the complete set of randomized cards for withdrawal from the card-handling device 204. As specific, nonlimiting examples, the card-handling device 204 may present a packet of cards representing a single hand or a packet of cards representing a group of hands, each hand including three cards (such as the three player cards, the three dealer cards, and the first three community cards, with the last two community cards provided as a set of three cards from one a last card is burned), as described previously in connection with FIGS. 1A and 1B.

Packets of cards used as player hands, partial player hands, dealer hands, partial dealer hands, community cards, or other card groups may be formed internally within the shuffler, such as within an internal compartment, as described in the '574 patent, or may be formed in an output tray of the shuffler. For example, U.S. Pat. No. 6,698,756, issued Mar. 2, 2004, to Baker et al., describes such a device. Other suitable shufflers include U.S. Pat. No. 6,267,248, issued Jul. 31, 2001, to Johnson et al, which describes a shuffler that can form a random set of cards, such as a deck or multiple decks; U.S. Pat. No. 7,766,332, issued Aug. 3, 2010, to Grauzer et al., which describes forming groups of player and/or dealer cards in compartments within a shuffler; U.S. Patent App. Pub. No. 2014/0027979, published Jan. 30, 2014, to Stasson et al., which shows an alternate method of randomly forming a set of cards in a shuffler such as one or more decks of cards; and U.S. Pat. No. 6,588,750, issued Jul. 8, 2003, to Grauzer et al., which shows a device for randomizing a set of cards using a gripping, lifting, and insertion sequence. The disclosure of each of the foregoing documents is incorporated herein in its entirety by this reference.

In some embodiments, the card-handling device 204 may employ a random number generator device (e.g., in addition to the random number generator 151 for randomly selecting the multiplier) to determine card order, such as, for example, a final card order or an order of insertion of cards into a compartment configured to form a packet of cards. The compartments may be sequentially numbered, and a random number assigned to each compartment number prior to delivery of the first card. In other embodiments, the random number generator may select a location in the stack of cards to separate the stack into two sub-stacks, creating an insertion point within the stack at a random location. The next card may be inserted into the insertion point. In yet other embodiments, the random number generator may randomly select a location in a stack to randomly remove cards by activating an ejector.

Other functions of the additional random number generator may be game-specific. For example, a random number generator internal or external to the shuffler may be used to randomly select a player to receive a first packet of cards, including a hand or a portion of a hand, according to the game rules. In other examples, the additional random number generator may select a game position to receive an extra card, one less card, or a random number of cards, depending upon the specific rules of the game.

Regardless of whether the random number generator (or generators) is hardware or software, it may be used to implement specific game administrations methods of the present disclosure.

The card-handling device 204 may simply be supported on the gaming surface 202 in some embodiments. In other embodiments, the card-handling device 204 may be mounted into the gaming table 202 such that the card-handling device 204 is not manually removable from the gaming table 202 without the use of tools. In some embodiments, the deck or decks of playing cards used may be standard, 52-card decks. In other embodiments, the deck or decks used may include cards, such as, for example, jokers, wild cards, bonus cards, etc. The shuffler may also be configured to handle and dispense security cards, such as cut cards.

In some embodiments, the card-handling device 204 may include an electronic display 207 (such as the display 152 of FIG. 2) for displaying information related to the wagering game being administered, such as the randomly selected multiplier for the initial election event. For additional examples, the electronic display 207 may display a menu of game options, the name of the game selected, the number of cards per hand to be dispensed, acceptable amounts for other wagers (e.g., maximums and minimums), numbers of cards to be dealt to recipients, locations of particular recipients for particular cards, winning and losing wagers, pay tables, winning hands, losing hands, and payout amounts. In other embodiments, information related to the wagering game may be displayed on another electronic display, such as, for example, the display 210 described previously.

The type of card-handling device 204 employed to administer embodiments of the disclosed wagering game, as well as the type of card deck employed and the number of decks, may be specific the game to be implemented. Cards used in games of this disclosure may be, for example, standard playing cards from one or more decks, each deck having cards of four suits (clubs, hearts, diamonds, and spades) and of rankings ace, king, queen, jack, and ten through two in descending order. As a more specific example, six, seven, or eight standard decks of such cards may be intermixed. Typically, six or eight decks of 52 standard playing cards each may be intermixed and formed into a set. A suitable device employing random number generation for card management and randomization is marketed under the name MD3® by Bally Gaming, Inc. of Las Vegas, Nev. Aspects of this device are described in U.S. Pat. No. 8,579,289, issued Nov. 12, 2013, to Rynda et al., and the shuffling mechanism is fully described in U.S. Pat. No. 7,677,565, issued Mar. 16, 2010, to Grauzer et al., the disclosure of each of which is incorporated herein in its entirety by this reference. After shuffling, the randomized set may be transferred into another portion of the card-handling device 204B or another card-handling device 204A altogether, such as a mechanized shoe capable of reading card rank and suit. More specifically, the shoe disclosed in, for example, U.S. Pat. No. 8,511,684, issued Aug. 20, 2013, to Grauzer et al., the disclosure of which is incorporated herein in its entirety by this reference, may be used to automatically dispense one or more cards at a time from the randomized set.

The gaming table 200 may include one or more chip racks 208 (such as the chip rack 139 of FIG. 2) configured to facilitate accepting wagers, transferring lost wagers to the house, and exchanging monetary value for wagering elements 212 (e.g., chips). For example, the chip rack 208 may include a series of token support rows, each of which may support tokens of a different type (e.g., color and denomination). In some embodiments, the chip rack 208 may be configured to automatically present a selected number of chips using a chip-cutting-and-delivery mechanism. Additional details of an illustrative chip rack 208 and chip-cutting-and-delivery mechanism are found in U.S. Pat. No. 7,934,980, issued May 3, 2011, to Blaha et al., the disclosure of which is incorporated herein in its entirety by this reference. In some embodiments, the gaming table 200 may include a drop box 214 for money that is accepted in exchange for wagering elements 212. The drop box 214 may be, for example, a secure container (e.g., a safe or lockbox) having a one-way opening into which money may be inserted and a secure, lockable opening from which money may be retrieved. Such drop boxes 214 are known in the art, and may be incorporated directly into the gaming table 200 and may, in some embodiments, have a removable container for the retrieval of money in a separate, secure location.

When administering a wagering game in accordance with embodiments of this disclosure, a dealer 216 may receive money (e.g., cash) from a player in exchange for wagering elements 212. The dealer 216 may deposit the money in the drop box 214 and transfer physical wagering elements 212 to the player. The dealer 216 may accept one or more initial wagers (e.g., the ante wager and optional bonus wagers) from the player, which may be reflected by the dealer 216 permitting the player to place one or more wagering elements 212 or other wagering tokens (e.g., cash) within designated areas (e.g., areas 122, 126, 128) on the gaming surface 202 associated with the various wagers of the wagering game. Once initial wagers have been accepted, the dealer 216 may remove physical cards 206 from the card-handling device 204 (e.g., individual cards, packets of cards, or the complete set of cards) in some embodiments. In other embodiments, the physical cards 206 may be hand-pitched (i.e., the dealer 216 may optionally shuffle the cards 206 to randomize the set and may hand-deal cards 206 from the randomized set of cards). The dealer 216 may position cards 206 within designated areas on the gaming surface 202, which may designate the cards 206 for use as individual player cards, community cards, or dealer cards in accordance with game rules. House rules also may allow the player to place only one wager (i.e., the play wager) during card distribution and after the initial wagers have been placed, or after card distribution but before all cards available for play are revealed.

After dealing the cards 206, and during play, according to the game rules, any additional wagers (e.g., the play wager) may be accepted, which may be reflected by the dealer 216 permitting the player to place one or more wagering elements 212 within the designated area (i.e., area 124) on the gaming surface 202 associated with the play wager of the wagering game. In some embodiments, a player may fold, which may result in the dealer 216 collecting at least the wagering elements 212 from the Ante wager area 122 associated with that player and transferring it to the house, which may be reflected by the wagering element 212 being returned to the chip rack 208. The dealer 216 may perform any additional card dealing and rounds of betting permitted in the wagering game. Finally, the dealer 216 may resolve the wagers, award winning wagers to the players, which may be accomplished by giving wagering elements 212 from the chip rack 208 to the players, and transferring losing wagers to the house, which may be accomplished by moving wagering elements 212 from the players to the chip rack 208.

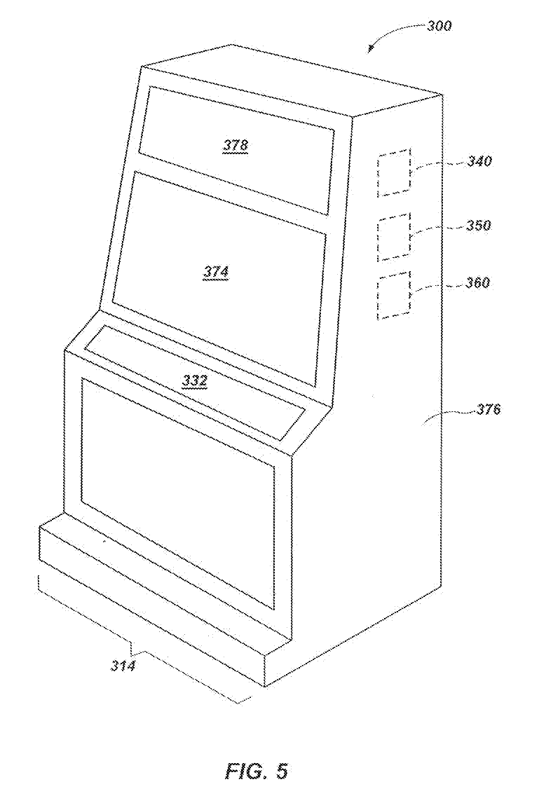

FIG. 5 is a perspective view of an individual electronic gaming device 300 (e.g., an electronic gaming machine (EGM)) configured for implementing wagering games according to this disclosure. The individual electronic gaming device 300 may include an individual player position 314 including a player input area 332 configured to enable a player to interact with the individual electronic gaming device 300 through various input devices (e.g., buttons, levers, touchscreens). The player input area 332 may further includes a cash- or ticket-in receptor, by which cash or a monetary-valued ticket may be fed, by the player, to the individual electronic gaming device 300, which may then detect, in association with game-logic circuitry in the individual electronic gaming device 300, the physical item (cash or ticket) associated with the monetary value and then establish a credit balance for the player. In other embodiments, the individual electronic gaming device 300 detects a signal indicating an electronic wager was made. Wagers may then be received, and covered by the credit balance, upon the player using the player input area 332 or elsewhere on the machine (such as through a touch screen). Won payouts and pushed or returned wagers may be reflected in the credit balance at the end of the round, the credit balance being increased to reflect won payouts and pushed or returned wagers and/or decreased to reflect lost wagers.

The individual electronic gaming device 300 may further include, in the individual player position 312, a ticket-out printer or monetary dispenser through which a payout from the credit balance may be distributed to the player upon receipt of a cashout instruction, input by the player using the player input area 332.

The individual electronic gaming device 300 may include a gaming screen 374 configured to display indicia for interacting with the individual electronic gaming device 300, such as through processing one or more programs stored in game-logic circuitry providing memory 340 to implement the rules of game play at the individual electronic gaming device 300. Accordingly, in some embodiments, game play may be accommodated without involving physical playing cards, chips or other wagering elements, and live personnel. The action may instead be simulated by a control processor 350 operably coupled to the memory 340 and interacting with and controlling the individual electronic gaming device 300.

Although the individual electronic gaming device 300 displayed in FIG. 5 has an outline of a traditional gaming cabinet, the individual electronic gaming device 300 may be implemented in other ways, such as, for example, client software downloaded to a portable device, such as a smart phone, tablet, or laptop computer. The individual electronic gaming device 300 may also be a non-portable personal computer (e.g., a desktop or all-in-one computer) or other computing device. In some embodiments, client software is not downloaded but is native to the device or is otherwise delivered with the device when distributed. In such embodiments, the credit balance may be established by receiving payment via credit card or player's account information input into the system by the player. Cashouts of the credit balance may be allotted to a player's account or card.

A communication device 360 may be included and operably coupled to the processor 350 such that information related to operation of the individual electronic gaming device 300, information related to the game play, or combinations thereof may be communicated between the individual electronic gaming device 300 and other devices, such as a server, through a suitable communication medium, such, as, for example, wired networks, Wi-Fi networks, and cellular communication networks.

The gaming screen 374 may be carried by a generally vertically extending cabinet 376 of the individual electronic gaming device 300. The individual electronic gaming device 300 may further include banners to communicate rules of game play and the like, such as along a top portion 378 of the cabinet 376 of the individual electronic gaming device 300. The individual electronic gaming device 300 may further include additional decorative lights (not shown), and speakers (not shown) for transmitting and optionally receiving sounds during game play. Further detail of an example of an individual electronic gaming device 300 (as well as other embodiments of tables and devices) is disclosed in U.S. patent application Ser. No. 13/963,165, filed Aug. 9, 2013, and titled “METHODS AND SYSTEMS FOR ELECTRONIC GAMING,” the disclosure of which is incorporated herein in its entirety by this reference.

Some embodiments may be implemented at locations including a plurality of player stations. Such player stations may include an electronic display screen for display of game information (e.g., cards, randomly selected multipliers, wagers, and game instructions) and for accepting wagers and facilitating credit balance adjustments. Such player stations may, optionally, be integrated in a table format, may be distributed throughout a casino or other gaming site, or may include both grouped and distributed player stations.

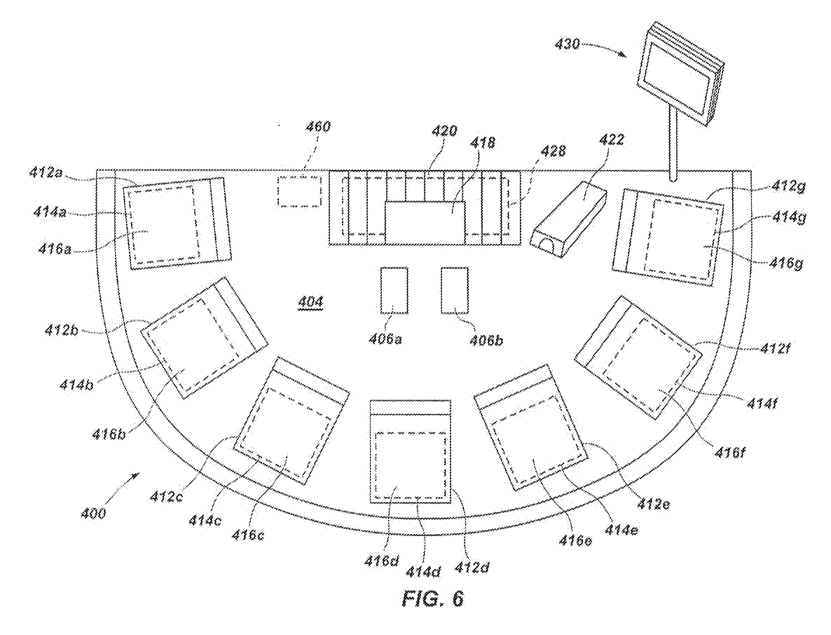

FIG. 6 is a top view of a suitable table 400 configured for implementing wagering games according to this disclosure. The table 400 may include a playing surface 404. The table 400 may include player stations 412. Each player station 412 may include a player interface 416, which may be used for displaying game information (e.g., graphics illustrating the player layout 120 of FIGS. 2 and 3, the randomly selected multiplier for the initial play election event, game instructions, input options, wager information, game outcomes, etc.) and accepting player elections. The player interface 416 may be a display screen in the form of a touch screen, which may be at least substantially flush with the playing surface 404 in some embodiments. Each player interface 416 may be operated by its own local game processor 414 (shown in dashed lines), although, in some embodiments, a central game processor 428 (shown in dashed lines) may be employed and may communicate directly with player interfaces 416. In some embodiments, a combination of individual local game processors 414 and the central game processor 428 may be employed. Each of the processors 414 and 428 may be operably coupled to memory including one or more programs related to the rules of game play at the table 400.

A communication device 460 may be included and may be operably coupled to one or more of the local game processors 414, the central game processor 428, or combinations thereof, such that information related to operation of the table 400, information related to the game play, or combinations thereof may be communicated between the table 400 and other devices through a suitable communication medium, such as, for example, wired networks, Wi-Fi networks, and cellular communication networks.

The table 400 may further include additional features, such as a dealer chip tray 420, which may be used by the dealer to cash players in and out of the wagering game, whereas wagers and balance adjustments during game play may be performed using, for example, virtual chips (e.g., images or text representing wagers). For embodiments using physical cards 406a and 406b, the table 400 may further include a card-handling device 422, which may be configured to randomly select the multiplier for the initial election event, to display the randomly selected multiplier, and to shuffle, read, and deliver physical cards for the dealer and players to use during game play or, alternatively, a card shoe configured to read and deliver cards that have already been randomized. For embodiments using virtual cards, the virtual cards may be displayed at the individual player interfaces 416. Common virtual cards may be displayed in a common card area.

The table 400 may further include a dealer interface 418, which, like the player interfaces 416, may include touch screen controls for receiving dealer inputs and assisting the dealer in administering the wagering game. The table 400 may further include an upright display 430 configured to display images that depict game information such as the randomly selected multiplier, pay tables, hand counts, historical win/loss information by player, and a wide variety of other information considered useful to the players. The upright display 430 may be double sided to provide such information to players as well as to casino personnel.

Further detail of an example of a table and player displays is disclosed in U.S. Pat. No. 8,262,475, issued Sep. 11, 2012, and titled “CHIPLESS TABLE SPLIT SCREEN FEATURE,” the disclosure of which is incorporated herein in its entirety by this reference. Although an embodiment is described showing individual discrete player stations, in some embodiments, the entire playing surface 404 may be an electronic display that is logically partitioned to permit game play from a plurality of players for receiving inputs from, and displaying game information to, the players, the dealer, or both.

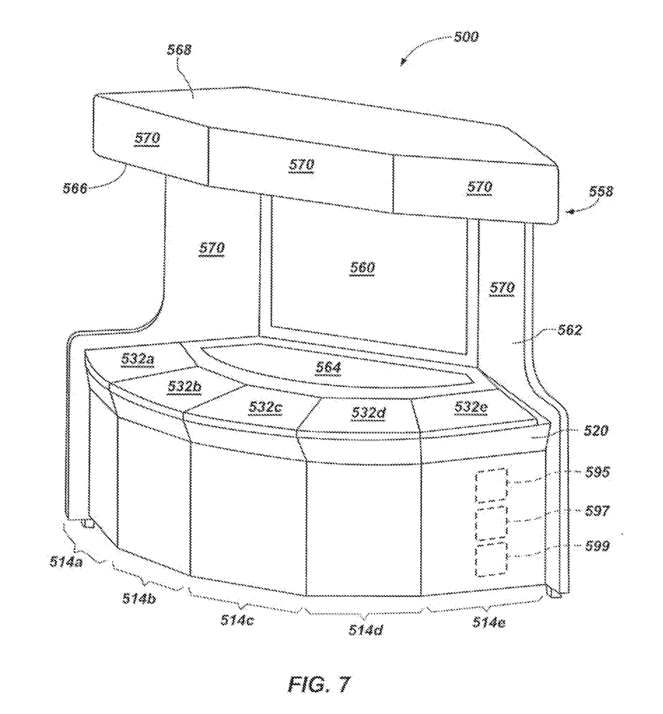

FIG. 7 is a perspective view of another embodiment of a suitable table 500 configured for implementing wagering games according to the present disclosure utilizing a virtual dealer. The table 500 may include player positions 514 arranged in a bank about an arcuate edge 520 of a video device 558 that may comprise a card screen 564 and a dealer screen 560. The dealer screen 560 may display a video simulation of the dealer (i.e., a virtual dealer) for interacting with the video device 558, such as through processing one or more stored programs stored in memory 595 to implement the rules of game play at the video device 558. The dealer screen 560 may be carried by a generally vertically extending cabinet 562 of the video device 558. The card screen 564 may be configured to display at least one or more of the dealer's cards, any community cards, and player's cards by the virtual dealer on the dealer screen 560.

Each of the player positions 514 may include a player interface area 532 displaying the player layout 120 of FIGS. 2 and 3 and configured for wagering and game play interactions with the video device 558 and virtual dealer. Accordingly, game play may be accommodated without involving physical playing cards, poker chips, and live personnel. The action may instead be simulated by a control processor 597 interacting with and controlling the video device 558. The control processor 597 may be programmed, by known techniques, to implement the rules of game play at the video device 558. As such, the control processor 597 may interact and communicate with display/input interfaces and data entry inputs for each player interface area 532 of the video device 558. Other embodiments of tables and gaming devices may include a control processor that may be similarly adapted to the specific configuration of its associated device.

A communication device 599 may be included and operably coupled to the control processor 597 such that information related to operation of the table 500, information related to the game play, or combinations thereof may be communicated between the table 500 and other devices, such as a central server, through a suitable communication medium, such, as, for example, wired networks, Wi-Fi networks, and cellular communication networks.

The video device 558 may further include banners communicating rules of play and the like, which may be located along one or more walls 570 of the cabinet 562. The video device 558 may further include additional decorative lights and speakers, which may be located on an underside surface 566, for example, of a generally horizontally extending top 568 of the cabinet 562 of the video device 558 generally extending toward the player positions 514.

Further detail of an example of a table and player displays is disclosed in U.S. Pat. No. 8,272,958, issued Sep. 25, 2012, and titled “AUTOMATED MULTIPLAYER GAME TABLE WITH UNIQUE IMAGE FEED OF DEALER,” the disclosure of which is incorporated herein in its entirety by this reference. Although an embodiment is described showing individual discrete player stations, in some embodiments, the entire playing surface (e.g., player interface areas 532, card screen 564, etc.) may be a unitary electronic display that is logically partitioned to permit game play from a plurality of players for receiving inputs from, and displaying game information to, the players, the dealer, or both.

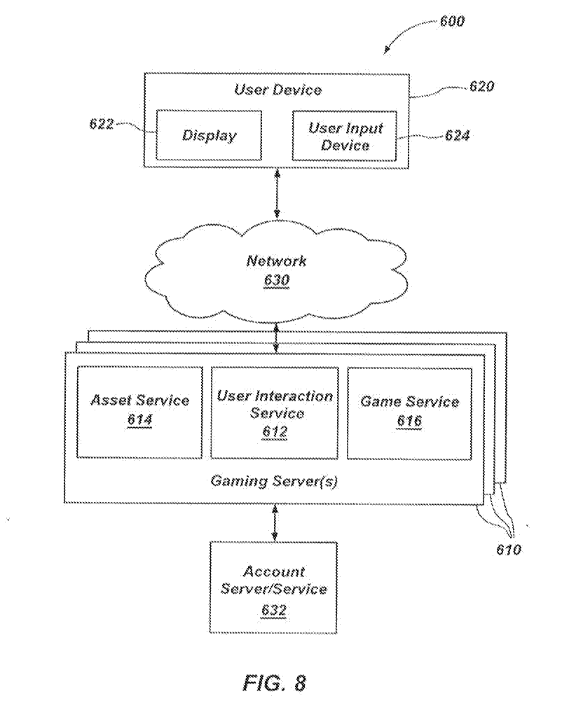

In some embodiments, wagering games in accordance with this disclosure may be administered using a gaming system employing a client-server architecture (e.g., over the Internet, a local area network, etc.). FIG. 8 is a schematic block diagram of an illustrative gaming system 600 for implementing wagering games according to this disclosure. The gaming system 600 may enable end users to remotely access game content. Such game content may include, without limitation, various types of wagering games such as card games, dice games, big wheel games, roulette, scratch off games (“scratchers”), and any other wagering game where the game outcome is determined, in whole or in part, by one or more random events. This includes, but is not limited to, Class II and Class III games as defined under 25 U.S.C. §2701 et seq. (“Indian Gaming Regulatory Act”). Such games may include banked and/or non-banked games.

The wagering games supported by the gaming system 600 may be operated with real currency or with virtual credits or other virtual (e.g., electronic) value indicia. For example, the real currency option may be used with traditional casino and lottery-type wagering games in which money or other items of value are wagered and may be cashed out at the end of a game session. The virtual credits option may be used with wagering games in which credits (or other symbols) may be issued to a player to be used for the wagers. A player may be credited with credits in any way allowed, including, but not limited to, a player purchasing credits; being awarded credits as part of a contest or a win event in this or another game (including non-wagering games); being awarded credits as a reward for use of a product, casino, or other enterprise, time played in one session, or games played; or may be as simple as being awarded virtual credits upon logging in at a particular time or with a particular frequency, etc. Although credits may be won or lost, the ability of the player to cash out credits may be controlled or prevented. In one example, credits acquired (e.g., purchased or awarded) for use in a play-for-fun game may be limited to non-monetary redemption items, awards, or credits usable in the future or for another game or gaming session. The same credit redemption restrictions may be applied to some or all of credits won in a wagering game as well.

An additional variation includes web-based sites having both play-for-fun and wagering games, including issuance of free (non-monetary) credits usable to play the play-for-fun games. This feature may attract players to the site and to the games before they engage in wagering. In some embodiments, a limited number of free or promotional credits may be issued to entice players to play the games. Another method of issuing credits includes issuing free credits in exchange for identifying friends who may want to play. In another embodiment, additional credits may be issued after a period of time has elapsed to encourage the player to resume playing the game. The gaming system 600 may enable players to buy additional game credits to allow the player to resume play. Objects of value may be awarded to play-for-fun players, which may or may not be in a direct exchange for credits. For example, a prize may be awarded or won for a highest scoring play-for-fun player during a defined time interval. All variations of credit redemption are contemplated, as desired by game designers and game hosts (the person or entity controlling the hosting systems).

The gaming system 600 may include a gaming platform to establish a portal for an end user to access a wagering game hosted by one or more gaming servers 610 over a network 630. In some embodiments, games are accessed through a user interaction service 612. The gaming system 600 enables players to interact with a user device 620 through a user input device 624 and a display 622 and to communicate with one or more gaming servers 610 using a network 630 (e.g., the Internet). Typically, the user device is remote from the gaming server 610 and the network is the word-wide web (i.e., the Internet).

In some embodiments, the gaming servers 610 may be configured as a single server to administer wagering games in combination with the user device 620. In other embodiments, the gaming servers 610 may be configured as separate servers for performing separate, dedicated functions associated with administering wagering games. Accordingly, the following description also discusses “services” with the understanding that the various services may be performed by different servers or combinations of servers in different embodiments. As shown in FIG. 8, the gaming servers 610 may include a user interaction service 612, a game service 616, and an asset service 614. In some embodiments, one or more of the gaming servers 610 may communicate with an account server 632 performing an account service 632. As explained more fully below, for some wagering type games, the account service 632 may be separate and operated by a different entity than the gaming servers 610; however, in some embodiments the account service 632 may also be operated by one or more of the gaming servers 610.

The user device 620 may communicate with the user interaction service 612 through the network 630. The user interaction service 612 may communicate with the game service 616 and provide game information to the user device 620. In some embodiments, the game service 616 may also include a game engine. The game engine may, for example, access, interpret, and apply game rules. In some embodiments, a single user device 620 communicates with a game provided by the game service 616, while other embodiments may include a plurality of user devices 620 configured to communicate and provide end users with access to the same game provided by the game service 616. In addition, a plurality of end users may be permitted to access a single user interaction service 612, or a plurality of user interaction services 612, to access the game service 616. The user interaction service 612 may enable a user to create and access a user account and interact with game service 616. The user interaction service 612 may enable users to initiate new games, join existing games, and interface with games being played by the user.

The user interaction service 612 may also provide a client for execution on the user device 620 for accessing the gaming servers 610. The client provided by the gaming servers 610 for execution on the user device 620 may be any of a variety of implementations depending on the user device 620 and method of communication with the gaming servers 610. In one embodiment, the user device 620 may connect to the gaming servers 610 using a web browser, and the client may execute within a browser window or frame of the web browser. In another embodiment, the client may be a stand-alone executable on the user device 620.

For example, the client may comprise a relatively small amount of script (e.g., JAVASCRIPT®), also referred to as a “script driver,” including scripting language that controls an interface of the client. The script driver may include simple function calls requesting information from the gaming servers 610. In other words, the script driver stored in the client may merely include calls to functions that are externally defined by, and executed by, the gaming servers 610. As a result, the client may be characterized as a “thin client.” The client may simply send requests to the gaming servers 610 rather than performing logic itself. The client may receive player inputs, and the player inputs may be passed to the gaming servers 610 for processing and executing the wagering game. In some embodiments, this may involve providing specific graphical display information for the display 622 as well as game outcomes.

As another example, the client may comprise an executable file rather than a script. The client may do more local processing than does a script driver, such as calculating where to show what game symbols upon receiving a game outcome from the game service 616 through user interaction service 612. In some embodiments, portions of an asset service 614 may be loaded onto the client and may be used by the client in processing and updating graphical displays. Some form of data protection, such as end-to-end encryption, may be used when data is transported over the network 630. The network 630 may be any network, such as, for example, the Internet or a local area network.

The gaming servers 610 may include an asset service 614, which may host various media assets (e.g., text, audio, video, and image files) to send to the user device 620 for presenting the various wagering games to the end user. In other words, the assets presented to the end user may be stored separately from the user device 620. For example, the user device 620 requests the assets appropriate for the game played by the user; as another example, especially relating to thin clients, just those assets that are needed for a particular display event will be sent by the gaming servers 610, including as few as one asset. The user device 620 may call a function defined at the user interaction service 612 or asset service 614, which may determine which assets are to be delivered to the user device 620 as well as how the assets are to be presented by the user device 620 to the end user. Different assets may correspond to the various user devices 620 and their clients that may have access to the game service 616 and to different variations of wagering games.

The gaming servers 610 may include the game service 616, which may be programmed to administer wagering games and determine game play outcomes to provide to the user interaction service 612 for transmission to the user device 620. For example, the game service 616 may include game rules for one or more wagering games, such that the game service 616 controls some or all of the game flow for a selected wagering game as well as the determined game outcomes. The game service 616 may include pay tables and other game logic. The game service 616 may perform random number generation for determining random game elements of the wagering game. In one embodiment, the game service 616 may be separated from the user interaction service 612 by a firewall or other method of preventing unauthorized access to the game service 612 by the general members of the network 630.

The user device 620 may present a gaming interface to the player and communicate the user interaction from the user input device 624 to the gaming servers 610. The user device 620 may be any electronic system capable of displaying gaming information, receiving user input, and communicating the user input to the gaming servers 610. For example, the user device 620 may be a desktop computer, a laptop, a tablet computer, a set-top box, a mobile device (e.g., a smartphone), a kiosk, a terminal, or another computing device. As a specific, nonlimiting example, the user device 620 operating the client may be an interactive electronic gaming system 300 (see FIG. 5), as described above. The client may be a specialized application or may be executed within a generalized application capable of interpreting instructions from an interactive gaming system, such as a web browser.

The client may interface with an end user through a web page or an application that runs on a device including, but not limited to, a smartphone, a tablet, or a general computer, or the client may be any other computer program configurable to access the gaming servers 610. The client may be illustrated within a casino webpage (or other interface) indicating that the client is embedded into a webpage, which is supported by a web browser executing on the user device 620.

In some embodiments, components of the gaming system 600 may be operated by different entities. For example, the user device 620 may be operated by a third party, such as a casino or an individual, that links to the gaming servers 610, which may be operated, for example, by a wagering game service provider. Therefore, in some embodiments, the user device 620 and client may be operated by a different administrator than the operator of the game service 616. In other words, the user device 620 may be part of a third-party system that does not administer or otherwise control the gaming servers 610 or game service 616. In other embodiments, the user interaction service 612 and asset service 614 may be operated by a third-party system. For example, a gaming entity (e.g., a casino) may operate the user interaction service 612, user device 620, or combination thereof to provide its customers access to game content managed by a different entity that may control the game service 616, amongst other functionality. In still other embodiments, all functions may be operated by the same administrator. For example, a gaming entity (e.g., a casino) may elect to perform each of these functions in-house, such as providing access to the user device 620, delivering the actual game content, and administering the gaming system 600.

The gaming servers 610 may communicate with one or more external account servers 632 (also referred to herein as an account service 632), optionally through another firewall. For example, the gaming servers 610 may not directly accept wagers or issue payouts. That is, the gaming servers 610 may facilitate online casino gaming but may not be part of a self-contained online casino itself. Another entity (e.g., a casino or any account holder or financial system of record) may operate and maintain its external account service 632 to accept bets and make payout distributions. The gaming servers 610 may communicate with the account service 632 to verify the existence of funds for wagering and to instruct the account service 632 to execute debits and credits. As another example, the gaming servers 610 may directly accept bets and make payout distributions, such as in the case where an administrator of the gaming servers 610 operates as a casino.

Additional features may be supported by the gaming servers 610, such as hacking and cheating detection, data storage and archival, metrics generation, messages generation, output formatting for different end user devices, as well as other features and operations. For example, the gaming servers 610 may include additional features and configurations as described in U.S. patent application Ser. No. 13/353,194, filed Jan. 18, 2012, and U.S. patent application Ser. No. 13/609,031, filed Sep. 10, 2012, both applications titled “NETWORK GAMING ARCHITECTURE, GAMING SYSTEMS, AND RELATED METHODS,” the disclosure of each of which is incorporated herein in its entirety by this reference.

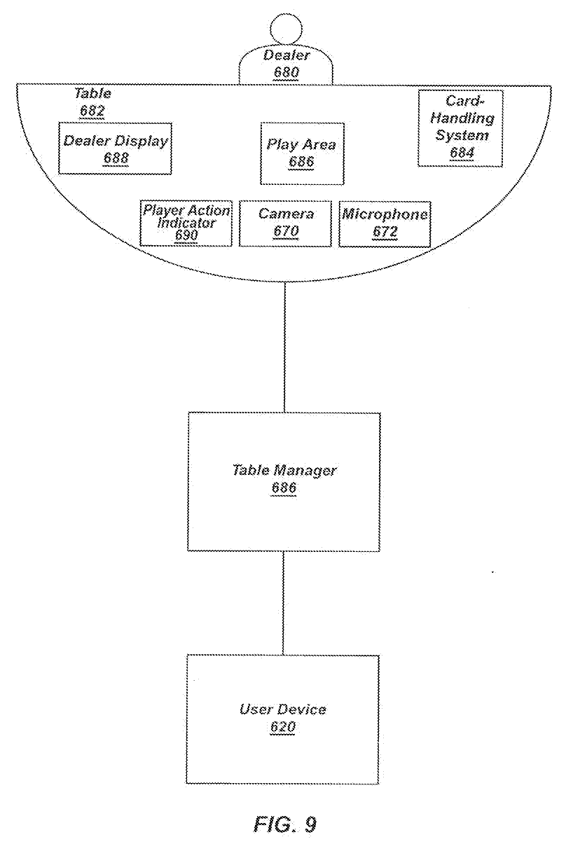

FIG. 9 is a schematic block diagram of a table 682 for implementing wagering games including a live dealer feed. Features of the gaming system 600 (see FIG. 8) described above in connection with FIG. 8 may be utilized in connection with this embodiment, except as further described. Rather than cards being determined by computerized random processes, physical cards (e.g., from a standard, 52-card deck of playing cards) may be dealt by a live dealer 680 at a table 682 from a card-handling system 684. A table manager 686 may assist the dealer 680 in facilitating play of the game by transmitting a video feed of the dealer's actions to the user device 620 and transmitting player elections to the dealer 680. As described above, the table manager 686 may act as or communicate with a gaming system 600 (see FIG. 8) (e.g., acting as the gaming system 600 (see FIG. 8) itself or as an intermediate client interposed between and operationally connected to the user device 620 and the gaming system 600 (see FIG. 8)) to provide gaming at the table 682 to users of the gaming system 600 (see FIG. 8). Thus, the table manager 686 may communicate with the user device 620 through a network 630 (see FIG. 8), and may be a part of a larger online casino, or may be operated as a separate system facilitating game play. In various embodiments, each table 682 may be managed by an individual table manager 686 constituting a gaming device, which may receive and process information relating to that table. For simplicity of description, these functions are described as being performed by the table manager 686, though certain functions may be performed by an intermediary gaming system 600 (see FIG. 8), such as the one shown and described in connection with FIG. 8. In some embodiments, the gaming system 600 (see FIG. 8) may match remotely located players to tables 682 and facilitate transfer of information between user devices 620 and tables 682, such as wagering amounts and player option elections, without managing gameplay at individual tables. In other embodiments, functions of the table manager 686 may be incorporated into a gaming system 600 (see FIG. 8).

The table 682 includes a camera 670 and optionally a microphone 672 to capture video and audio feeds relating to the table 682. The camera 670 may be trained on the dealer 680, play area 687, and card-handling system 684. As the game is administered by the dealer 680, the video feed captured by the camera 670 may be shown to the player using the user device 620, and any audio captured by the microphone 672 may be played to the player using the user device 620. In some embodiments, the user device 620 may also include a camera, microphone, or both, which may also capture feeds to be shared with the dealer 680 and other players. In some embodiments, the camera 670 may be trained to capture images of the card faces, chips, and chip stacks on the surface of the gaming table. Known image extraction techniques may be used to obtain card count and card rank and suit information from the card images. An example of suitable image extraction software is disclosed in U.S. Pat. No. 7,901,285, issued Mar. 8, 2011, to Tran et al., the disclosure of which is incorporated in this disclosure in its entirety by this reference.

Card and wager data in some embodiments may be used by the table manager 686 to determine game outcome. The data extracted from the camera 670 may be used to confirm the card data obtained from the card-handling system 684, to determine a player position that received a card, and for general security monitoring purposes, such as detecting player or dealer card switching, for example. Examples of card data include, for example, suit and rank information of a card, suit and rank information of each card in a hand, rank information of a hand, and rank information of every hand in a round of play.

The live video feed permits the dealer to show cards dealt by the card-handling system 684 and play the game as though the player were at a live casino. In addition, the dealer can prompt a user by announcing a player's election is to be performed. In embodiments where a microphone 672 is included, the dealer 680 can verbally announce action or request an election by a player. In some embodiments, the user device 620 also includes a camera or microphone, which also captures feeds to be shared with the dealer 680 and other players.

The card-handling system 684 may be as shown and described previously in connection with FIG. 4. The play area 686 depicts player layouts for playing the game, such as shown in FIGS. 2 and 3. As determined by the rules of the game, the player at the user device 620 may be presented options for responding to an event in the game using a client as described with reference to FIG. 8.

Player elections may be transmitted to the table manager 686, which may display player elections to the dealer 680 using a dealer display 688 and player action indicator 690 on the table 682. For example, the dealer display 688 may display information regarding where to deal the next card or which player position is responsible for the next action.

In some embodiments, the table manager 686 may receive card information from the card-handling system 684 to identify cards dealt by the card-handling system 684. For example, the card-handling system 684 may include a card reader to determine card information from the cards. The card information may include the rank and suit of each dealt card and hand information.

The table manager 686 may apply game rules to the card information, along with the accepted player decisions, to determine gameplay events and wager results. Alternatively, the wager results may be determined by the dealer 680 and input to the table manager 686, which may be used to confirm automatically determined results by the gaming system.

Card and wager data in some embodiments may be used by the table manager 686 to determine game outcome. The data extracted from the camera 670 may be used to confirm the card data obtained from the card-handling system 684, to determine a player position that received a card, and for general security monitoring purposes, such as detecting player or dealer card switching, for example.

The live video feed permits the dealer to show cards dealt by the card-handling system 684 and play the game as though the player were at a live casino. In addition, the dealer can prompt a user by announcing a player's election is to be performed. In embodiments where a microphone 672 is included, the dealer 680 can verbally announce action or request an election by a player. In some embodiments, the user device 620 also includes a camera or microphone, which also captures feeds to be shared with the dealer 680 and other players.

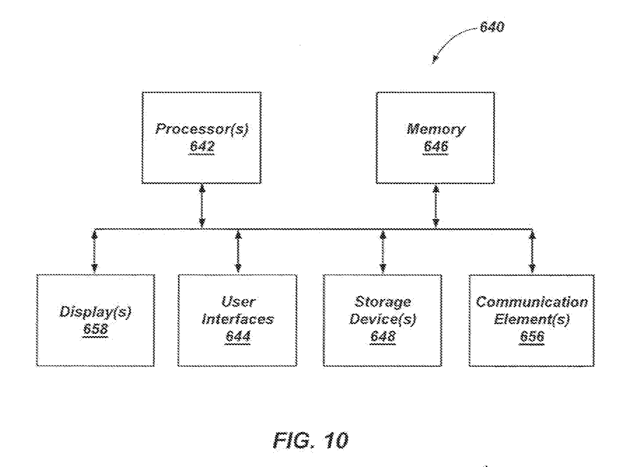

FIG. 10 is a simplified block diagram showing elements of computing devices that may be used in systems and apparatuses of this disclosure. A computing system 640 may be a user-type computer, a file server, a computer server, a notebook computer, a tablet, a handheld device, a mobile device, or other similar computer system for executing software. The computing system 640 may be configured to execute software programs containing computing instructions and may include one or more processors 642, memory 646, one or more displays 658, one or more user interface elements 644, one or more communication elements 656, and one or more storage devices 648 (also referred to herein simply as storage 648).

The processors 642 may be configured to execute a wide variety of operating systems and applications including the computing instructions for administering wagering games of the present disclosure.

The processors 642 may be configured as a general-purpose processor such as a microprocessor, but in the alternative, the general-purpose processor may be any processor, controller, microcontroller, or state machine suitable for carrying out processes of the present disclosure. The processor 642 may also be implemented as a combination of computing devices, such as a combination of a DSP and a microprocessor, a plurality of microprocessors, one or more microprocessors in conjunction with a DSP core, or any other such configuration.

A general-purpose processor may be part of a general-purpose computer. However, when configured to execute instructions (e.g., software code) for carrying out embodiments of the present disclosure the general-purpose computer should be considered a special-purpose computer. Moreover, when configured according to embodiments of the present disclosure, such a special-purpose computer improves the function of a general-purpose computer because, absent the present disclosure, the general-purpose computer would not be able to carry out the processes of the present disclosure. The processes of the present disclosure, when carried out by the special-purpose computer, are processes that a human would not be able to perform in a reasonable amount of time due to the complexities of the data processing, decision making, communication, interactive nature, or combinations thereof for the present disclosure. The present disclosure also provides meaningful limitations in one or more particular technical environments that go beyond an abstract idea. For example, embodiments of the present disclosure provide improvements in the technical field related to the present disclosure.

The memory 646 may be used to hold computing instructions, data, and other information for performing a wide variety of tasks including administering wagering games of the present disclosure. By way of example, and not limitation, the memory 646 may include Synchronous Random Access Memory (SRAM), Dynamic RAM (DRAM), Read-Only Memory (ROM), Flash memory, and the like.

The display 658 may be a wide variety of displays such as, for example, light-emitting diode displays, liquid crystal displays, cathode ray tubes, and the like. In addition, the display 658 may be configured with a touch-screen feature for accepting user input as a user interface element 644.

As nonlimiting examples, the user interface elements 644 may include elements such as displays, keyboards, push-buttons, mice, joysticks, haptic devices, microphones, speakers, cameras, and touchscreens.

As nonlimiting examples, the communication elements 656 may be configured for communicating with other devices or communication networks. As nonlimiting examples, the communication elements 656 may include elements for communicating on wired and wireless communication media, such as for example, serial ports, parallel ports, Ethernet connections, universal serial bus (USB) connections, IEEE 1394 (“firewire”) connections, THUNDERBOLT™ connections, BLUETOOTH® wireless networks, ZigBee wireless networks, 802.11 type wireless networks, cellular telephone/data networks, and other suitable communication interfaces and protocols.

The storage 648 may be used for storing relatively large amounts of nonvolatile information for use in the computing system 640 and may be configured as one or more storage devices. By way of example and not limitation, these storage devices may include computer-readable media (CRM). This CRM may include, but is not limited to, magnetic and optical storage devices such as disk drives, magnetic tape, CDs (compact discs), DVDs (digital versatile discs or digital video discs), and semiconductor devices such as RAM, DRAM, ROM, EPROM, Flash memory, and other equivalent storage devices.

A person of ordinary skill in the art will recognize that the computing system 640 may be configured in many different ways with different types of interconnecting buses between the various elements. Moreover, the various elements may be subdivided physically, functionally, or a combination thereof. As one nonlimiting example, the memory 646 may be divided into cache memory, graphics memory, and main memory. Each of these memories may communicate directly or indirectly with the one or more processors 642 on separate buses, partially combined buses, or a common bus.

As a specific, nonlimiting example, various methods and features of the present disclosure may be implemented in a mobile, remote, or mobile and remote environment over one or more of Internet, cellular communication (e.g., Broadband), near field communication networks and other communication networks referred to collectively herein as an iGaming environment. The iGaming environment may be accessed through social media environments such as FACEBOOK® and the like. DragonPlay Ltd, acquired by Bally Technologies Inc., provides an example of a platform to provide games to user devices, such as cellular telephones and other devices utilizing ANDROID®, iPHONE® and FACEBOOK® platforms. Where permitted by jurisdiction, the iGaming environment can include pay-to-play (P2P) gaming where a player, from their device, can make value based wagers and receive value based awards. Where P2P is not permitted the features can be expressed as entertainment only gaming where players wager virtual credits having no value or risk no wager whatsoever such as playing a promotion game or feature.

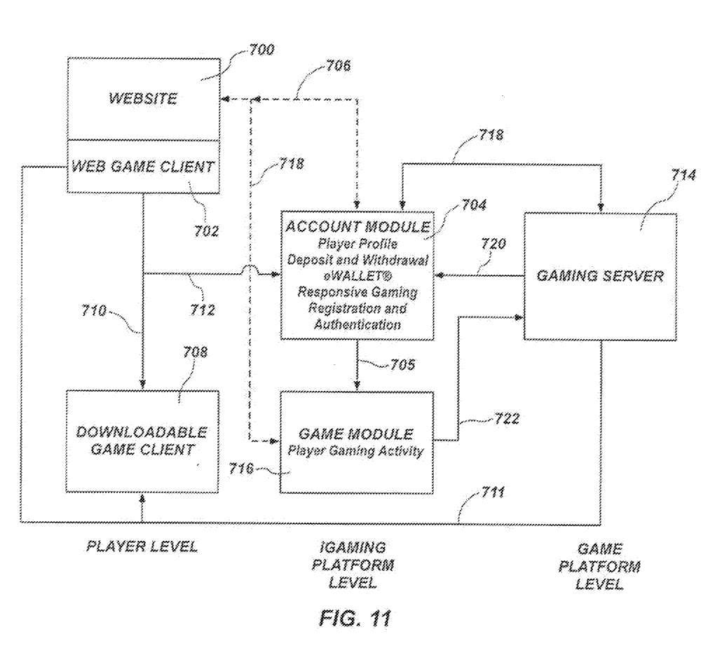

FIG. 11 illustrates an illustrative embodiment of information flows in an iGaming environment. At a player level, the player or user accesses a site hosting the activity such as a website 700. The website 700 may functionally provide a web game client 702. The web game client 702 may be, for example, represented by a game client 708 downloadable at information flow 710, which may process applets transmitted from a gaming server 714 at information flow 711 for rendering and processing game play at a player's remote device. Where the game is a P2P game, the gaming server 714 may process value-based wagers (e.g., money wagers) and randomly generate an outcome for rendition at the player's device. In some embodiments, the web game client 702 may access a local memory store to drive the graphic display at the player's device. In other embodiments, all or a portion of the game graphics may be streamed to the player's device with the web game client 702 enabling player interaction and display of game features and outcomes at the player's device.

The website 700 may access a player-centric, iGaming-platform-level account module 704 at information flow 706 for the player to establish and confirm credentials for play and, where permitted, access an account (e.g., an eWallet) for wagering. The account module 704 may include or access data related to the player's profile (e.g., player-centric information desired to be retained and tracked by the host), the player's electronic account, deposit, and withdrawal records, registration and authentication information, such as username and password, name and address information, date of birth, a copy of a government issued identification document, such as a driver's license or passport, and biometric identification criteria, such as fingerprint or facial recognition data, and a responsible gaming module containing information, such as self-imposed or jurisdictionally imposed gaming restraints, such as loss limits, daily limits and duration limits. The account module 704 may also contain and enforce geo-location limits, such as geographic areas where the player may play P2P games, user device IP address confirmation, and the like.

The account module 704 communicates at information flow 705 with a game module 716 to complete log-ins, registrations, and other activities. The game module 716 may also store or access a player's gaming history, such as player tracking and loyalty club account information. The game module 716 may provide static web pages to the player's device from the game module 716 through information flow 718, whereas, as stated above, the live game content may be provided from the gaming server 714 to the web game client through information flow 711.

The gaming server 714 may be configured to provide interaction between the game and the player, such as receiving wager information, game selection, inter-game player selections or choices to play a game to its conclusion, and the random selection of game outcomes and graphics packages, which, alone or in conjunction with the downloadable game client 708/web game client 702 and game module 716, provide for the display of game graphics and player interactive interfaces. At information flow 718, player account and log-in information may be provided to the gaming server 714 from the account module 704 to enable gaming. Information flow 720 provides wager/credit information between the account module 704 and gaming server 714 for the play of the game and may display credits and eWallet availability. Information flow 722 may provide player tracking information for the gaming server 714 for tracking the player's play. The tracking of play may be used for purposes of providing loyalty rewards to a player, determining preferences, and the like.

All or portions of the features of FIG. 11 may be supported by servers and databases located remotely from a player's mobile device and may be hosted or sponsored by regulated gaming entity for P2P gaming or, where P2P is not permitted, for entertainment only play.

In some embodiments, wagering games may be administered in an at least partially player-pooled format, with payouts on pooled wagers being paid from a pot to players and losses on wagers being collected into the pot and eventually distributed to one or more players. Such player-pooled embodiments may include a player-pooled progressive embodiment, in which a pot is eventually distributed when a predetermined progressive-winning hand combination or composition is dealt. Player-pooled embodiments may also include a dividend refund embodiment, in which at least a portion of the pot is eventually distributed in the form of a refund distributed, e.g., pro-rata, to the players who contributed to the pot.

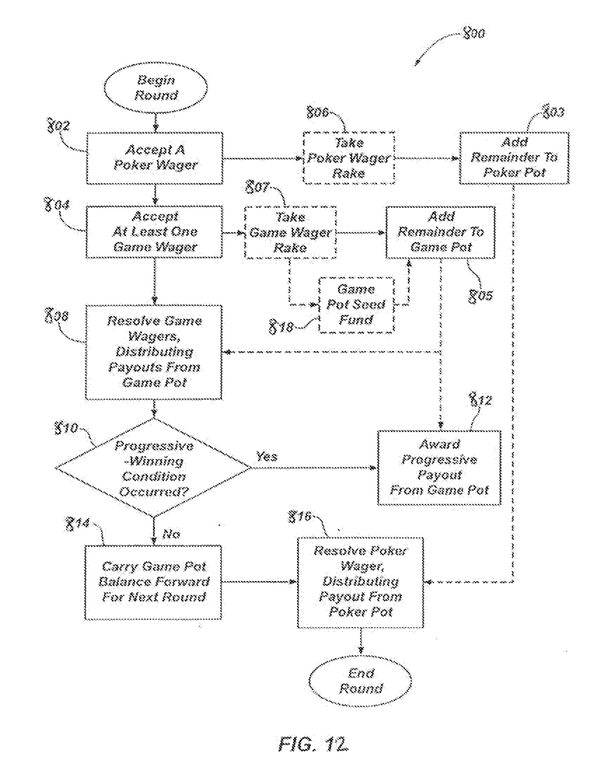

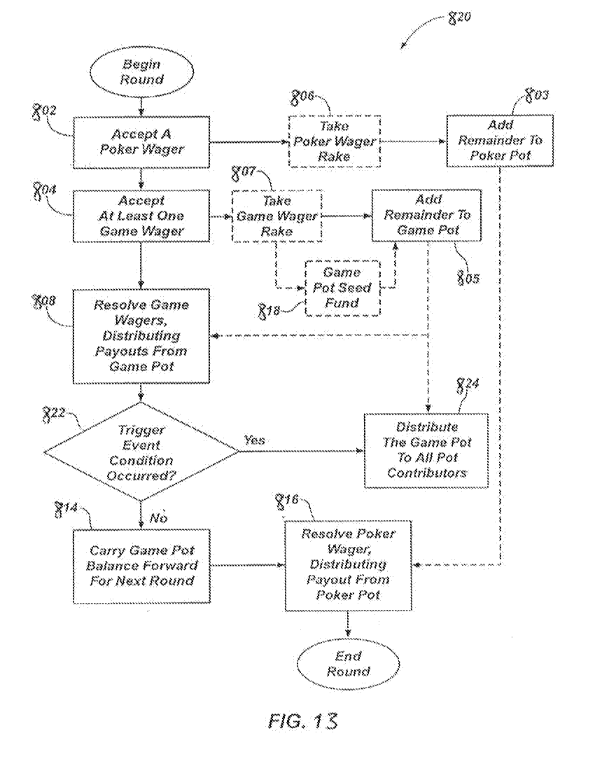

In some player-pooled embodiments, the game administrator may not obtain profits from chance-based events occurring in the wagering games that result in lost wagers. Instead, lost wagers may be redistributed back to the players. To profit from the wagering game, the game administrator may retain a commission, such as, for example, a player entrance fee or a rake taken on wagers, such that the amount obtained by the game administrator in exchange for hosting the wagering game is limited to the commission and is not based on the chance events occurring in the wagering game itself. The game administrator may also charge a rent of flat fee to participate. Specific, illustrative mechanisms for redistributing the lost wagers back to players are described in connection with FIGS. 12 and 13.

Referring to FIG. 12, shown is a flowchart diagram of a method 800 of administering a wagering game, which may be at least partially player-pooled, according to a player-pooled progressive embodiment. The method 800 includes accepting a first mandatory wager, referred to herein as a “poker wager,” as indicated at 802. At least a portion of the poker wager is added to a poker pot, as indicated at operation 803. The poker wager may be later resolved by comparing player hands and awarding the poker pot, or at least a portion thereof, to the player holding a highest ranking poker hand (e.g., a highest ranking five-card player hand or a highest ranking seven-card player hand) in that round of play. For example, in a five-card game, four-of-a-kind would outrank a three-of-a-kind.

The poker pot may be a nonprogressive pot; more specifically, all or substantially all of the poker pot may be distributed at the conclusion of each round of the wagering game. In some embodiments, the poker wager may be a mandatory wager to qualify the player for play of the underlying wagering game. In other embodiments, the poker wager may be optional, and the wagering game may be administered to a player without receiving the poker wager and without qualifying the player for a potential payout from the poker pot.

At least one game wager may also be accepted, as indicated at 804. The game wagers may include, for example, base game wagers (e.g., ante wagers, play wagers, and any other wagers made on the underlying wagering game), bonus (side) wagers, or both. More specifically, the game wagers may comprise, for example, the ante wager, the bonus wager(s), and the play wager. At least a portion of each game wager is added to a game pot, as indicated at operation 805, which game pot may be a progressive pot.

In some embodiments, acceptance of the at least one game wager qualifies a player to be eligible to win an award in addition to the payouts available from the underlying game (i.e., the 1 to 1 payout on the ante wager and the play wager; the bonus payouts on the bonus wagers; and the bonus award (e.g., the ante bonus)), such as, for example, a progressive payout (e.g., a progressive jackpot awarded to one or more qualifying players). Therefore, in some such embodiments, a progressive wager may be received, in addition to the other game wagers received from the player, such as the ante wager, the play wager, and the bonus wager(s). In other such embodiments, one of the game wagers may be converted to a progressive wager, such as, for example, one or more of the bonus wagers. In some embodiments, the progressive wager may be a mandatory wager to qualify the player for play of the underlying wagering game. In other embodiments, the progressive wager may be optional, and the wagering game may be administered to a player without receiving the progressive wager, in addition to any other game wagers, from the player and without qualifying the player to be eligible to win the progressive payout from the game pot.

In some embodiments, the poker wager and the at least one game wager may be received as indistinct wagers, with a portion thereof being designated for the poker pot (a non-progressive pot) and another portion being designated for the game pot (a progressive pot).

In some embodiments, the game pot may be a pooled or linked pot. For example, the game pot may include one or more game wagers accepted from multiple concurrent wagering games. As another example, the game pot may include pooled progressive wagers from those wagering games currently being played and may include accumulated game wagers from past wagering games. As specific, nonlimiting examples, the game pot may include all game wagers accepted from a group of electronic gaming tables or other local wagering game administration devices at a casino, from multiple groups of remote devices connected to network gaming architecture, or both. In other embodiments, the game pot may not be pooled, and awards for the game wager may be limited to the amounts wagered at a respective electronic gaming table, other local wagering game administration device, or group of remote devices.

The game administrator may take a “rake” (e.g., a commission for the house) on at least one wager, such as the poker wager, as indicated at operation 806, the at least one game wager, as indicated at operation 807, or both. In some embodiments, therefore, a rake may be taken on all wagers, or any wager. For example, the house may collect a portion of the poker wager at the time the poker wager is placed. Additionally or alternatively, the house may collect a portion of the game wagers at the time the game wagers are placed.

The rake may be, for example, a fixed percentage of the wagers. More specifically, the percentage of the wagers collected for the rake may be, for example, greater than a theoretical house advantage for the underlying game. As another example, the rake may be less than an average house advantage for play of the wagering game by all players, including average and sub-average players, which may be calculated using a historical house advantage for the wagering game (e.g., a house advantage for the wagering game over the last 5, 10, or 15 years for a given casino or other gaming establishment). As specific, nonlimiting examples, the percentage of the wagers (i.e., either or both of the poker wager and the at least one game wager) collected for the rake may be between 3% and 8%, between 4% and 7%, or between 5% and 6%. In other embodiments, the portion of the wagers collected for the rake may be a variable percentage of the wagers or may be a fixed quantity (e.g., a flat fee) irrespective of the total amount for the wagers, a fixed percentage with a cap, or a time-based fee for increments of time playing the wagering game. Thus, in lieu of, or in addition to, a rake taken on one or more wagers, the house may be compensated in a number of other ways, including, without limitation, a flat fee per round of play, a percentage of wagers made with or without a cap, rental of a player “seat,” or otherwise as is known in the gaming art. All such compensation may be generally referred to as a “commission.”

All profits for the house may be made from the rake (or rakes or other commission) in some player-banked embodiments. In such embodiments, wagered amounts in excess of the rake are distributed either in the form of, for example, a progressive payout (as in a “player-pooled progressive” embodiment (FIG. 12)), a dividend refund (as in a “dividend refund” embodiment (FIG. 13)), or some combination thereof. Thus, the profits for the house may be limited. Such limiting of profits for the house and redistribution of wagers back to one or more players may increase the attractiveness of the wagering game to both inexperienced and highly skilled players. Because the amount earned by the house is known, highly skilled players may perceive that their skill will enable them to increase winnings, and inexperienced players may be enticed by the possibility of winning or otherwise earning a portion or all of one or more of the pots. In other embodiments, the house may make profits on the rake and on losses from one or more of the wagers (e.g., the ante wager, the bonus wager(s), and the play wager), including losses resulting from optimal and suboptimal play.

The rake may be maintained in a rake account, and profits for the house may be deducted from the rake account. When and if taken from the poker wagers, the poker wager rake (operation 806) may be taken by, for example, electronically transferring funds from the poker wagers to a poker pot rake account (e.g., as instructed by a game service 616 (see FIG. 8) using casino account servers 632 (see FIG. 8)). Likewise, when and if taken from the game wagers, the game wager rake (operation 807) may be taken by, e.g., electronically transferring funds from the game pot wagers to a game pot rake account (e.g., as instructed by the game service 616 (see FIG. 8) using casino account servers 632 (see FIG. 8)).

In some embodiments, the poker wager may be accepted (operation 802) at the beginning of a round of administration of the wagering game. One or more of the game wagers may be accepted (operation 804) at the beginning of the round as well, e.g., the ante wager and the bonus wager(s). In some embodiments, additional game wagers may be accepted (operation 804), possibly raked (operation 807), and added to the game pot (operation 805) in the intermediate segments of the round of play, e.g., the play wager.

The underlying wagering game may be played as described above, including resolving the game wagers received during the round of play, as indicated at operation 808. For example, the underlying wagering game may be played at least substantially as described previously in connection with FIGS. 1 through 3. Payouts to be distributed, as a result of resolving the game wagers, (e.g., payouts on the ante wager, the play wager, the bonus wager(s), and the bonus award (e.g., ante bonus)), are paid from the game pot.

It is contemplated that only a portion of the game pot may be distributed, at operation 806, in the form of payouts on the underlying game. At least in embodiments in which the game pot is configured as a progressive pot (e.g., if one of the game wagers is a progressive wager or one game outcome of a low frequency pays the amount of the pot), all or substantially all of the remaining portion of the game pot may be designated for a potential progressive payout. For example, administering the player-pooled progressive embodiment of the player-pooled wagering game may include determining whether a progressive-winning condition has occurred, as indicated at operation 810. A progressive-winning condition may be predefined as a predetermined winning hand combination being dealt, which may result in an award of, for example, a portion of the game pot, or a premium winning hand composition being dealt, which may result in an award of, for example, an entire amount of the game pot. If such a progressive-winning condition has occurred during the round of game administration, a progressive payout may be awarded to the winning-hand-holding player, with the progressive payout being paid from the game pot, as indicated at operation 812. As just one example, a game may pay a progressive payout for a seven-card player hand of a royal flush or a five-card player hand of a royal flush. If no progressive-winning condition has occurred, a progressive payout may not be paid from the game pot, but, rather, the game pot balance may be carried forward for the next round of play and so on, as indicated at operation 814, until a progressive-winning condition occurs during a subsequent round. Thus, the game pot may not be awarded at the end of each round of play, but may grow during each successive round in which no player is dealt a predetermined winning hand combination or a premium winning hand composition. However, if the underlying game payouts distributed at operation 808, or if a progressive payout is awarded at operation 812, without draining the game pot, the game pot may decrement until the game pot contributions, at operation 805, rebuild the game pot.

A predetermined winning hand combination may be, for example, a four-of-a-kind, a full house, a flush, a straight, a three-of-a-kind, two pair, or one pair in the five-card player hand. The hands qualifying as new winning hand combinations may be predetermined at the beginning of each round of play in some embodiments. In other embodiments, new winning hand combinations may be predetermined at the beginning of play and may remain fixed until it is determined that at least one player hand achieves a predetermined winning hand combination, at which time new winning hand combinations may be predetermined. In still other embodiments, the hand combinations qualifying as winning hand combinations may be predetermined at the outset of the wagering game and remain fixed for the duration of the wagering game. The hands qualifying as winning hand combinations may be predetermined at random from a list of possible winning hand combinations, from among a schedule with a fixed rotation of possible winning hand combinations, or using a fixed table of winning hand combinations.

A premium winning hand composition may be, for example, a four-of-a-kind, a straight flush, or a royal flush in the five-card player hand. The hand compositions qualifying as premium winning hand compositions may remain fixed throughout the duration of the wagering game or may change during the wagering game. For example, after it has been determined that a player hand has achieved a premium winning hand composition, the hand compositions qualifying as premium winning hand compositions may be made more restrictive or less restrictive. As a specific, nonlimiting example, after identification of a player hand achieving a straight flush, the hand compositions qualifying as premium winning hand compositions may be restricted to royal flushes or may be expanded to include four-of-a-kinds. The hands qualifying as premium winning hand compositions may be predetermined at random from a list of possible premium winning hand compositions, following a schedule with a fixed rotation of possible premium winning hand compositions, or according to a fixed table of premium winning hand compositions.

In embodiments in which the game pot is a progressive pot, the amount awarded from the game pot for achieving a premium winning hand composition may be a progressive payout at least as great as a maximum progressive payout for achieving a predetermined winning hand composition. For example, the entire game pot may be awarded when a player or multiple players are dealt a premium winning hand composition, and only a portion of the game pot may be awarded when a player or multiple players are dealt a predetermined winning hand combination.

Awarding the game pot or a portion of the game pot may involve crediting a player account with funds from the game pot or may comprise distributing physical money or physical representations of money from the game pot to the player.

Before, between, or after resolving the game wagers (operation 808), determining whether a progressive-winning condition occurred (operation 810), awarding a progressive payout (operation 812), or any combination thereof, the poker wager may be resolved, and the poker pot may be awarded to at least one player, as indicated at operation 816. Each successive round of receiving wagers, dealing cards, and resolving wagers may constitute a round of play, and the poker pot may be awarded to at least one player before the end of each round of play. The player to whom the poker pot is awarded may hold a highest ranking five-card hand of all hands dealt in a round on a table using conventional poker rankings, or a ranking system specific to the disclosed games when compared to the hands of other players at the virtual “table.”

Awarding the poker pot or the portion of the poker pot may involve crediting a player account of each winning player or may comprise distributing physical money or physical representations of money to each winning player.

In some embodiments, an entire amount of the poker pot may be awarded to at least one player before the end of each round of play. In such embodiments, the poker pot may be a nonprogressive pot. Awarding the entire amount of a poker pot to at least one player at the end of each round of play redistributes lost poker wagers attributable to suboptimal play to other players, rather than to the house.

In some embodiments involving a no-house-advantage poker pot awarded at the end of each round and a progressive game pot that receives all other game wagers, all players participating in the wagering game from whom the at least one game wager has been received may be eligible to win the game pot or a portion of the game pot. Players who are ineligible to win the poker pot, and players from whom fold indications have been received but from whom one or more other active wagers in play have been received, may be eligible to win the game pot or a portion of the game pot.

In some embodiments, the game pot may be seeded with money from the game pot rake account or a reserve account (as indicated at operation 818) at the beginning of play, after the game pot or a portion of the game pot has been awarded, or both. In some embodiments, a minimum account balance sufficient to cover expected losses is retained when distributing a progressive payout (operation 812) such that no seed money is required in the game pot. For example, the game pot may be seeded from the rake account of the house (operation 818), and the house may maintain an amount of funds in the rake account sufficient to significantly reduce (e.g., to essentially eliminate) the likelihood that any payouts made from the rake account and any seeding amounts withdrawn from the rake account exhaust or overdraw the rake account. In some embodiments, a casino reserve account may be provided to fill the rake account in the event of an overdraw. Such seeding may incentivize players to participate in the wagering game, and specifically to place a game wager (e.g., a progressive wager) to be eligible for the progressive payout from the game pot. In addition, such seeding may reduce the likelihood that the amount of funds in the game pot may be insufficient to cover all the payouts to players. For example, where a player hand achieves a premium winning hand composition in one round of play, a player hand achieves a predetermined winning hand combination in the immediately following round of play, and a fixed-odds payout is to be awarded to the player holding the predetermined winning hand combination, the amount seeded to the game pot between those rounds of play may be at least as great as the maximum fixed-odds payout awardable for any predetermined winning hand combination. The game pot may be seeded each time the game pot is awarded in its entirety or each time the amount in the game pot is lower than the maximum fixed-odds payout.

FIG. 13 is a flowchart diagram of a method 820 of administering a wagering game, which may be at least partially player-pooled, according to a dividend refund embodiment. The method 820 is largely the same as the method 800 of the player-pooled progressive (FIG. 12), with the exception that, rather than determining whether a progressive-winning condition has occurred (operation 810 (FIG. 12)), the method 820 includes determining whether a trigger event condition has occurred, as indicated at operation 822, and, if so, distributing the game pot to one or more past or present players of the wagering game, as indicated at operation 824 (rather than distributing the game pot as a progressive payout as at operation 812 (FIG. 12)). In such embodiment, the game pot may accumulate between rounds of play, and, to periodically reduce the balance, a dividend (e.g., a share of the game pot awarded to each participating player) may be awarded to players from the game pot. Thus, what would otherwise be the profits from lost wagers, less amounts raked by the house, are redistributed back to the players, rather than collected by the house as revenue. Thus, the distribution is not a payout on the underlying game, but a refund.

The game pot may be distributed among a plurality of players upon the occurrence of a predetermined event (referred to herein as a “trigger event”), as indicated at operation 822. The predetermined, trigger event may not be based, for example, on player skill or chance events occurring in the underlying wagering game. The predetermined trigger event may comprise, for example, determination that at least one player participated for a predetermined number of hands; completed a predetermined number of rounds of play at a given table, electronic gaming machine, or remote gaming device; reached a predetermined time limit since play commenced; or reached a predetermined amount within the game pot. The predetermined trigger event or condition may be time-based, pot-based (or pool-based), game-based, amount-based, or other-based. Further details on pot distributions based on predetermined trigger events and conditions are disclosed in the U.S. patent application Ser. No. 13/871,824, filed Apr. 26, 2013, titled “DISTRIBUTING SUPPLEMENTAL POT IN WAGERING GAMES BASED ON PREDETERMINED EVENT,” the disclosure of which is incorporated herein in its entirety by this reference.

The dividend distributions may be divided at least among players currently participating in the wagering game. In some embodiments, the dividend distributions may also be paid to players who previously contributed to the game pot but who have since ceased participating in the wagering game. In some embodiments, the dividend distributions may not be paid to players from whom contributions to the game pot have not been received since the last dividend distribution was paid. The percentage of the game pot refunded to each player as a dividend distribution may be, for example, approximately equal to the percentage of hands won by each player, the percentage of first pot winnings won by each player based on game play, the percentage of total wager amounts received from each player, the proportional number of wagers received from each player, the proportional length of time spent playing the wagering game by each player, or an equal percentage for each player eligible to receive a dividend distribution from the game pot.

The dividend refund may be distributed in the form of a credit made to the receiving players' accounts. In some embodiments, the refund may be paid without concurrently alerting the player, though the refund may be noticeable when and if the player next checks his or her balance in his or her player account.

In some embodiments, wagering games may be administered without players risking money in connection with the wagers (i.e., “play-for-fun” games). Access to play-for-fun wagering games may be granted on a time period basis in some embodiments. For example, upon initially joining the wagering game, each player may automatically be given nonmonetary wagering elements, such as, for example, chips, points, or simulated currency, that are of no redeemable value. After joining, the player may be permitted to place bets using the wagering elements and a timer may track how long the player has been participating in the wagering game. If the player exhausts his or her supply of the wagering elements before a predetermined period of time has expired, the player may be permitted to simply wait until the period of time passes to rejoin the game, at which time access to another quantity of the wagering elements may be granted to the player to permit the player to resume participation in the wagering game.

In some embodiments, a hierarchy of players may determine the quantity of wagering elements given to a player for each predetermined period of time. For example, players who have been participating in the wagering game for a longer time, who have played closest to optimal strategy for the game, who have won the largest percentage of wagers, who have wagered the most in a play-for-pay environment, or who have won the largest quantities of wagering elements from their wagers may be given more wagering elements for each allotment of time than players who have newly joined, who have played according to poor strategy, who have lost more frequently, or who have lost larger quantities of wagering elements. In some embodiments, the hierarchy of players may determine the duration of each allotment of time. For example, players who have been participating in the wagering game for a longer time, who have played closest to optimal strategy for the game, who have won the largest percentage of wagers, or who have won the largest quantities of wagering elements from their wagers may be given shorter allotments of times to wait for an award of more wagering elements than players who have newly joined, who have played according to poor strategy, who have lost more frequently, or who have lost larger quantities of wagering elements. In some embodiments, players who have not run out of wagering elements after the period of time has expired may have the balance of their wagering elements reset for a subsequent allotment of time. In other embodiments, players who have not run out of wagering elements may be allowed to retain their remaining wagering elements for subsequent allotments of time, and may be given additional wagering elements corresponding to the new allotment of time to further increase the balance of wagering elements at their disposal. Players may be assigned to different categories of players, which determine the number of wagering elements awarded. In a given period of time, higher level players, or players who have invested more time playing the game may be allotted more wagering elements per unit of time than a player assigned to a lower level group.

Therefore, in some embodiments, the wagering game may be administered by receiving wagers (e.g., the ante wager, the play wager, the bonus wager(s)) of no real-world monetary value, and payouts (e.g., the payouts on the ante wager and the play wager; the payouts on the bonus wagers; and the bonus award (e.g., the ante bonus))) may be paid without transferring real-world monetary value to the players. Such embodiments, referred to herein as “free play-for-fun” embodiments are nonetheless contemplated as modes of carrying out the methods described herein.

In some embodiments, referred to herein as “social play-for-fun” embodiments, a player may be permitted to redeem an access token of no redeemable face value, such as, for example, points associated with a player account (e.g., social media account credits, online points associated with a transacting account, etc.), to compress the period of time and receive more wagering elements. The access tokens may be sold or may be given without directly exchanging money for the access tokens. For example, access tokens may be allocated to players who participate in member events (e.g., complete surveys, receive training on how to play the wagering game, share information about the wagering game with others), spend time participating in the wagering game or in a player account forum (e.g., logged in to a social media account), or view advertising. Thus, an entity administering social play-for-fun wagering games may not receive money from losing player wagers or may not take a rake on wagers, but may receive compensation through advertising revenue or through the purchase of access tokens redeemable for time compressions to continue play of the wagering game or simply to increase the quantity of wagering elements available to a player.

After receipt of an indication that a player has stopped participating in a play-for-fun wagering game (e.g., a free play-for-fun embodiment, a social play-for-fun embodiment), any remaining quantities of the wagering elements may be relinquished by the player and retained by the administrator, in some embodiments. For example, receipt of an indication that the player has logged out of a play-for-fun wagering game administered over the Internet may cause any remaining wagering elements associated with a respective player to be lost. Thus, when the player rejoins the play-for-fun wagering game, the quantity of wagering elements given to the player for an allotment of time may not bear any relationship to the quantity of wagering elements held by the player when he or she quit playing a previous session of the wagering game. In other embodiments, upon receipt of an indication that a player has stopped playing, the quantity of wagering elements held by the player at that time may be retained and made available to the player, along with any additional quantities of wagering elements granted for new allotments of time, upon receipt of an indication that the player has rejoined the wagering game.

While certain illustrative embodiments have been described in connection with the figures, those of ordinary skill in the art will recognize and appreciate that the scope of this disclosure is not limited to those embodiments explicitly shown and described herein. Rather, many additions, deletions, and modifications to the embodiments described herein may result in embodiments within the scope of this disclosure, such as those specifically claimed, including legal equivalents. In addition, features from one disclosed embodiment may be combined with features of another disclosed embodiment while still being within the scope of this disclosure, as contemplated by the inventors.

What is claimed is:

1. A method of administering a wagering game, comprising:
providing a gaming table comprising a surface illustrated to define a plurality of player layouts, each player layout illustrated to define at least one distinct wager area comprising an Ante wager area and only one Play wager area;
providing a shuffler device comprising a display and a random number generator programmed to randomly select a multiplier from a predefined set of multipliers; and
administering a round of the wagering game, comprising:
receiving an ante wager, in the Ante wager area of a player layout, of the plurality of player layouts, associated with a player;
using the random number generator of the shuffler device to randomly select the multiplier from the predefined set of multipliers;
displaying the multiplier on the display of the shuffler device;
distributing, from at least one deck of physical playing cards, three player cards comprising one excess player card;
distributing, from the at least one deck of physical playing cards, three dealer cards comprising one excess dealer card;
after the player discards the one excess player card, leaving two remaining player cards, receiving an initial election selected by the player from options of
a check election, and
a play wager, to occupy the only one Play wager area of the player layout, equal to the ante wager multiplied by the multiplier randomly selected by the random number generator of the shuffler device;
after receipt of the initial election, revealing, from the at least one deck of physical playing cards, community cards; and
resolving all received wagers,
the dealer retaining the three dealer cards, including the one excess dealer card, at least until all wagers in the round have been received.

2. The method of claim 1, wherein the predefined set of multipliers consist of multipliers greater than 1×.

3. The method of claim 1, wherein revealing, from the at least one deck of physical playing cards, community cards comprises:
revealing a set of community cards; and
after receipt of a final election selected by the player from final options, revealing another set of community cards.

4. The method of claim 3, wherein:
the set of community cards consists of three community cards; and
the another set of community cards consists of two community cards.

5. The method of claim 3, wherein the final options consists of a fold election and the play wager equal to the ante wager multiplied by another multiplier not in the predefined set of multipliers.

6. The method of claim 1, further comprising, after revealing, from the at least one deck of physical plying cards, the community cards, comparing a dealer hand, formed from the community cards and the three dealer cards, to a predetermined qualifying rank.

7. The method of claim 1, wherein resolving all received wagers comprises:
resolving the ante wager based at least in part on a comparison of a five-card player hand to a five-card dealer hand,
the five-card player hand formed from the two remaining player cards and the community cards, and
the five-card dealer hand formed from the three dealer cards and the community cards.

8. The method of claim 7, wherein resolving all received wagers further comprises resolving the play wager based at least in part on the comparison of the five-card play hand to the five-card dealer hand.

9. The method of claim 1:
further comprising receiving at least one bonus wager, in at least one Bonus wager area of the player layout, associated with the player; and
wherein resolving all received wagers comprises resolving the at least one bonus wager based at least on application of at least one pay table.

10. A method of administering a wagering game, comprising:
receiving an ante wager from a player;
distributing three player cards from a deck of physical playing cards;
distributing three dealer cards from the deck of physical playing cards;
operating a shuffler device to display, on a display of the shuffler device, a multiplier randomly selected, from a predefined set of multipliers, by a random number generator of the shuffler device;
receiving an initial election selected by the player from initial options consisting of
a check election, and
a play wager equal to the ante wager multiplied by the multiplier displayed on the display of the shuffler device;
after receipt of the initial election, after the player discards one of the three player cards to leave two remaining player cards, and before the dealer discards any of the three dealer cards, revealing three community cards from the deck of physical playing cards;
after revealing the three community cards and after receipt of the check election, receiving a final election selected by the player from final options consisting of
a fold election to sacrifice the ante wager, and
the play wager equal to the ante wager multiplied by another multiplier;
after receiving the final election, revealing another two community cards, to form five community cards, from the deck of physical playing cards; and
after receiving the final election and after revealing the another two community cards, forming a five-card dealer hand from the three dealer cards and the five community cards; and
resolving all received wagers still in play, comprising comparing the five-card dealer hand to a five-card player hand formed from the two remaining player cards and the five community cards.

11. The method of claim 10, wherein the another multiplier is less than all of the multipliers in the predefined set of multipliers.

12. The method of claim 10, wherein the predefined set of multipliers consists of a 2× multiplier, a 3× multiplier, and a 4× multiplier.

13. The method of claim 10, wherein the receipt of the initial election and the receipt of the final election are the only two opportunities to receive the play wager from the player.

14. The method of claim 10, wherein resolving all received wagers comprises resolving the ante wager and the play wager based on the comparison of the five-card dealer hand to the five-card player hand.

15. The method of claim 10:
further comprising, before distributing the three player cards and the three dealer cards, receiving a bonus wager from the player; and
wherein resolving all received wagers still in play further comprises resolving the bonus wager based at least in part on a seven-card player hand and a bonus pay table, the seven-card player hand consisting of the two remaining player cards and the five community cards.

16. The method of claim 10:
further comprising, before distributing the three player cards and the three dealer cards, receiving a bonus wager from the player; and
wherein resolving all received wagers still in play further comprises resolving the bonus wager based on a rank of a lower-ranked hand of the five-card dealer hand and the five-card player hand and a bad beat bonus pay table.

17. A game system, comprising:
a regulated gaming machine primarily dedicated to playing at least one casino wagering game, the gaming machine include an electronic display device and one or more electronic input devices; and
game-logic circuitry configured to:
detect, via at least one of the one or more electronic input devices, a physical item associated with a monetary value that establishes a credit balance;
initiate a round of a casino wagering game of the at least one casino wagering game in response to an input indicative of an ante wager covered by the credit balance; and
during the round of the casino wagering game:
randomly select a multiplier from a predefined set of multipliers;
display, on the electronic display device, the multiplier randomly selected;
randomly select, from a stored deck of playing cards, three player cards and three dealer cards;
display, on the electronic display device, the three player cards;
receive an instruction, input by the player using at least one of the one or more electronic input devices, directing a discard of one of the three player cards;
display, on the electronic display device, initial election options consisting of
a check election, and
a play wager election of an amount equal to the ante wager multiplied by the multiplier;
receive an instruction, input by the player using at least one of the one or more electronic input devices, associated with one of the initial election options;
randomly select, from the stored deck of playing cards, five community cards;
display, on the electronic display device, the five community cards;
after receipt of all wagers in the round of the casino wagering game, display on the electronic display device, the three dealer cards; and
resolve at least the ante wager based at least in part on a comparison of a five-card player hand against a five-card dealer hand, the five-card player hand formed from the five community cards and three player cards less the discard one of the three player cards, the five-card dealer hand formed from the five community cards and the three dealer cards.

18. The game system of claim 17, wherein the game-logic circuitry is further configured to, after display of a first set of the five community cards and before display of a second set of the five community cards, display final election options consisting of a fold election and the play wager equal to the ante wager.

19. The game system of claim 18, wherein:
the first set consists of three of the five community cards; and
the second set consists of two of the five community cards.

20. The game system of claim 17, wherein the game-logic circuitry is further configured to increase the credit balance by the ante wager upon the five-card dealer hand not at least equaling a predetermined qualifying ranking.
